(19) United States
(12) Patent Application Publication
(10) Pub. No.: US 2017/0206684 A1
(43) Pub. Date: Jul. 20, 2017

(54) INTELLIGENT CONTAINER FOR ANALYTIC VISUALIZATIONS

(71) Applicant: iCharts, Inc., Mountain View, CA (US)

(72) Inventors: Seymour Duncker, Los Altos, CA (US); Andrey Yruski, San Francisco, CA (US)

(21) Appl. No.: 15/401,900

(22) Filed: Jan. 9, 2017

Related U.S. Application Data
(60) Provisional application No. 62/278,915, filed on Jan. 14, 2016.

(51) Int. Cl. G06T 11/20; G06F 17/30; G06F 17/21; G06T 11/60; G06F 17/22

(52) U.S. Cl. CPC G06T 11/206; G06T 11/60; G06F 17/2247; G06F 17/212; G06F 17/30864; G06F 17/30572

(57) ABSTRACT

A first container embedded into a web portal is used to output a first analytic visualization that visualizes a first dataset. A second container embedded into a web portal is used to output a second analytic visualization that visualizes a second dataset. The contents of the first dataset and second dataset is different subsets of data from one or more data sources stored at one or more data servers. One or more update servers is situated communicatively between each of the containers and the corresponding data servers to ensure filtering of data is performed at the data servers and that no other data beside the first and second datasets reach the containers. Data is shared from the second container to the first container if the two containers share at least one data type. Data sharing is performed at the container level, the update server level, or the data server level.

### CROSS-REFERENCE TO RELATED APPLICATIONS

The present application claims the priority benefit of U.S. provisional application No. 62/278,915 filed Jan. 14, 2016 and entitled “Intelligent Container for Analytic Visualizations,” which is hereby incorporated by reference.

### BACKGROUND

1. Field of the Invention

The present invention generally relates to composite analytic visualizations. More specifically, the present invention relates to the secure transfer of data from multiple data sources for embedded analytic visualizations.

2. Description of the Related Art

With the continued proliferation of computing devices and the ubiquitous increase in Internet connectivity, dealing with vast quantities of data has become a norm in business and consumer markets. Viewing and manipulating such data while the data is still arranged in spreadsheets, tables, databases, and other data structures can often be slow, difficult, unwieldy, and in some cases, entirely unmanageable. Therefore, it is often helpful to arrange such data into analytic visualizations, such as charts or graphs. Typically, a user of spreadsheet software such as Microsoft Excel might manually import data through a data structure conversion process to generate a chart or graph from the data. The user may then export the chart or graph as a static image into a document or web page.

One problem with manually exporting analytic visualizations through spreadsheet software as static images is that there is no easy way to update, filter, interact with, or manipulate those visualizations if they are embedded into a web portal or similar medium where a viewer might expect data to be updated and interactive. In order to update such a static-image analytic visualization, someone must enter updated data into a spreadsheet, generate a new analytic visualization based on the updated data, export the updated analytic visualization as a new image, and embed the image into the web portal. Similarly, if a viewer would like to filter data in the visualization (e.g., view sales data for only the United States when viewing an analytic visualization showing worldwide sales data), the data owner would need to generate, export, and embed a separate analytic visualization with the filtered data.

A further problem is that there is no easy way to generate visualizations that are based on multiple sources of data, or to transfer data from a first chart to a second chart. Often, different data sources are stored in different types of data structures, are stored in different formats, are accessible through different software applications, or are associated with different networked data management services or systems. In order to generate an analytic visualization based on such different sources, the data owner typically needs to manually export data from a first data source and a from second data source and import the data into a combined data structure. This process alone may include numerous conversion steps. The data owner may then need to edit the data itself to convert units so that data can properly be compared (e.g., if the first data set includes distance data in miles while the second data set includes distance data in kilometers). Any mathematical operations between data from the first and second data sources must also then be manually prepared by the data owner. This slow, cumbersome, and sometimes unpredictable process must then be repeated any time either data source is updated, which can very quickly become unmanageable.

A further problem is that charts with any form of update mechanism are not designed to access data in a secure manner. Owners of data must often blindly trust third parties with their data to allow it any semblance of interactivity. Owners transfer large amounts of potentially sensitive data from multiple data sources to third-party servers for processing, thereby giving rise to the possibility that the third party will sell or leak potentially massive amounts of the data owner's data. Any sensitive data on such third party servers is further vulnerable to malicious hackers or snooping governmental entities if the network connections are compromised via a man-in-the-middle attack or if the third party servers themselves are compromised.

Another problem with image-based charts is that such charts cannot be made to be dynamic. As such, a viewer of a chart cannot interact with the chart, such as to trigger viewing of a sub-chart with information about a pie segment or bar or line or category within a main chart.

Similar problems exist with respect to personalization based on viewer permissions. Presently available systems display charts with the same level of detail and same viewable categories of data when displaying to a high-ranking company executive as to a lower-level company employee or to a member of the public. Nor do presently available systems allow for viewer interactivity with charts that update based on viewer actions and viewer inputs from the viewer of the chart.

There is, therefore, a need in the art for improved analytic visualization systems that maintain security while allowing for different levels of permissions, interactivity, and transfer of data between various data sources and various charts.

### SUMMARY OF THE CLAIMED INVENTION

One exemplary method for providing composite analytic visualization data includes identifying at least a first data type that characterizes at least a subset of a first dataset that is visualized in a first analytic visualization output to a viewer device by a first container, the first dataset including data stored at one or more data servers that was selected by the one or more data servers according to data processing instructions sent to the one or more data servers by one or more update servers communicatively coupled to the first container, the data processing instructions based at least partially on permissions associated with the viewer device. The method also includes transmitting a container query to a server associated with a second container displaying a second analytic visualization that visualizes a second dataset, the container query identifying at least the first data type. The method also includes receiving a container dataset from the server associated with the second container, the container dataset being at least a subset of the second dataset that matches the first data type. The method also includes generating a composite dataset based at least partially on at least a subset of the first dataset and at least a subset of the container dataset. The method also includes generating a composite analytic visualization that visualizes the composite dataset. The method also includes outputting the composite analytic visualization at the first container. The method also includes displaying the first container at the viewer device.

One exemplary system for providing composite analytic visualization data includes a first container outputting a first analytic visualization that visualizes a first dataset, the first container displayed to a viewer device. The system also includes a second container outputting a second analytic visualization that visualizes a second dataset. The system also includes a data server plugin stored at one or more data servers, wherein the one or more data servers also collectively store one or more data sources, wherein the first dataset includes at least a first selection of data from at least a first subset of the one or more data sources, the first selection of data based at least partially on permissions associated with the viewer device, and wherein the second dataset includes at least a second selection of data from at least a second subset of the one or more data sources. The system also includes one or more update servers communicatively coupled to the one or more data servers, wherein the first container is communicatively coupled to at least a first subset of the one or more update servers and the second container is communicatively coupled to at least a second subset of the one or more update servers, the one or more update servers including an update server memory and an update server processor. Execution of instructions stored in the update server memory by the update server processor performs a number of system operations. The system operations include identifying at least a first data type that characterizes at least a subset of the first dataset. The system operations also include transmitting a container query to a server associated with the second container, the container query identifying at least the first data type. The system operations also include receiving a container dataset from the server associated with the second container, the container dataset being at least a subset of the second dataset that matches the first data type. The system operations also include generating a composite dataset based at least partially on at least a subset of the first dataset and at least a subset of the container dataset. The system operations also include generating a visualization update based on the composite dataset. The system operations also include transmitting the visualization update to the first container, thereby allowing the first container to output a composite analytic visualization generated based on the composite dataset.

One exemplary stored program for providing composite analytic visualization data may be stored on a non-transitory computer-readable storage medium. The stored program may be executable by a processor to perform an exemplary method for providing composite analytic visualization data. The exemplary program method may include identifying at least a first data type that characterizes at least a subset of a first dataset that is visualized in a first analytic visualization output to a viewer device by a first container, the first dataset including data stored at one or more data servers that was selected by the one or more data servers according to data processing instructions sent to the one or more data servers by one or more update servers communicatively coupled to the first container, the data processing instructions based at least partially on permissions associated with the viewer device. The program method also includes transmitting a container query to a server associated with a second container displaying a second analytic visualization that visualizes a second dataset, the container query identifying at least the first data type. The program method also includes receiving a container dataset from the server associated with the second container, the container dataset being at least a subset of the second dataset that matches the first data type. The program method also includes generating a composite dataset based at least partially on at least a subset of the first dataset and at least a subset of the container dataset. The program method also includes generating a composite analytic visualization that visualizes the composite dataset. The program method also includes outputting the composite analytic visualization at the first container. The program method also includes displaying the first container at the viewer device.

### BRIEF DESCRIPTION OF THE FIGURES

FIG. 1 illustrates an exemplary composite analytic visualization ecosystem.

FIG. 2 illustrates data transfers performed to publish a composite analytic visualization within a container embedded in a portal.

FIG. 3 is a lane-based flow diagram illustrating the publishing of an exemplary composite analytic visualization within a container embedded in a portal.

FIG. 4 is a lane-based flow diagram illustrating the updating of a composite analytic visualization within a container embedded in a portal.

FIG. 5 illustrates three intelligent containers communicating with each other.

FIG. 6A is a flow diagram illustrating user device notifications based on container chart data.

FIG. 6B is a flow diagram illustrating user device notifications based on predictions based on container chart data.

FIG. 7A illustrates a first form of exemplary visualization update as transferred from an update server to a container embedded within a portal.

FIG. 7B illustrates a second form of exemplary visualization update as transferred from an update server to a container embedded within a portal.

FIG. 8 is a flow diagram illustrating data processing operations performed by a data server to generate a processed data set.

FIG. 9 illustrates an exemplary composite analytic visualization ecosystem with multiple data sources stored at multiple data servers.

FIG. 10 is a block diagram of an exemplary computing device that may be used to implement an embodiment of the present invention.

### DETAILED DESCRIPTION

A first container embedded into a web portal is used to output a first analytic visualization that visualizes a first dataset. A second container embedded into a web portal is used to output a second analytic visualization that visualizes a second dataset. The contents of the first dataset and second dataset is different subsets of data from one or more data sources stored at one or more data servers. One or more update servers is situated communicatively between each of the containers and the corresponding data servers to ensure filtering of data is performed at the data servers and that no other data beside the first and second datasets reach the containers. Data is shared from the second container to the first container if the two containers share at least one data type. Data sharing is performed at the container level, the update server level, or the data server level.

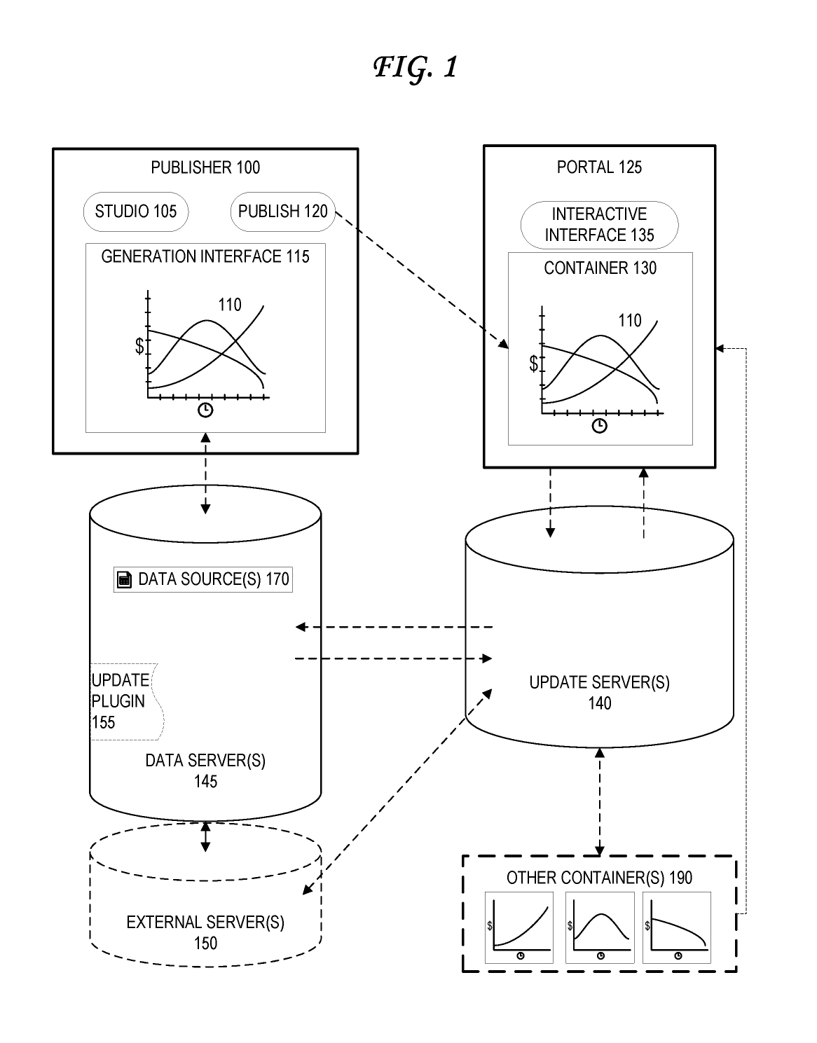

FIG. 1 illustrates an exemplary composite analytic visualization ecosystem. The analytic visualization ecosystem of FIG. 1 includes publisher 100, portal 125 with an embedded container 130 displaying an analytic visualization 110, update server(s) 140, data server(s) 145, external server(s) 150, and other container(s) 190.

The analytic visualization ecosystem may include network connections (not shown) that communicatively connect to one or more update server(s) 140, one or more data server(s) 145, one or more external server(s) 150, the portal 125 and container 130, the publisher 100, and one or more other container(s) 190. These network connections may include wired network connections (e.g. Ethernet, fiber optic) or wireless network connections (e.g. Wi-Fi, cellular telephone network connections, near-field communications, radio-frequency communications) or some combination thereof. These networks may pass through private networks, internet connections, or some combination thereof.

Different subsets of servers may be coupled in different ways. For example, the set of update servers 140 may include multiple subsets, each subset including one or more distinct update server(s). Likewise, the set of data servers 145 may include multiple subsets, each subset including one or more distinct data server(s). A first subset of the update servers 140 may be connected to a first subset of the data servers 145, while a second subset of the update servers 140 may be connected to a second subset of the data servers 145, and so on.

The portal 125 may be hosted on one or more portal server(s) (not shown) that may be may be connected to at least a subset of the update server(s) 140 through a network connection. The container 130 may be hosted on one or more container server(s) (not shown) that may be connected to at least a subset of the update server(s) 140 through a network connection. In some embodiments, the portal server(s) and container server(s) may be the same computer systems. The portal 125 may be displayed at one or more viewer device(s) (not shown).

At least a subset of the external server(s) 150 may be coupled via a network connection to at least a subset of the data server(s) 145, at least a subset of the update server(s) 140 or some combination thereof.

The publisher 100 may be hosted on a publisher server (not shown) that may be connected at least a subset of the data server(s) 145 and/or the external server(s) 150 through a network connection. The publisher 100 may also be connected to the portal server(s) (not shown) and/or the container server(s) (not shown) through a network connection.

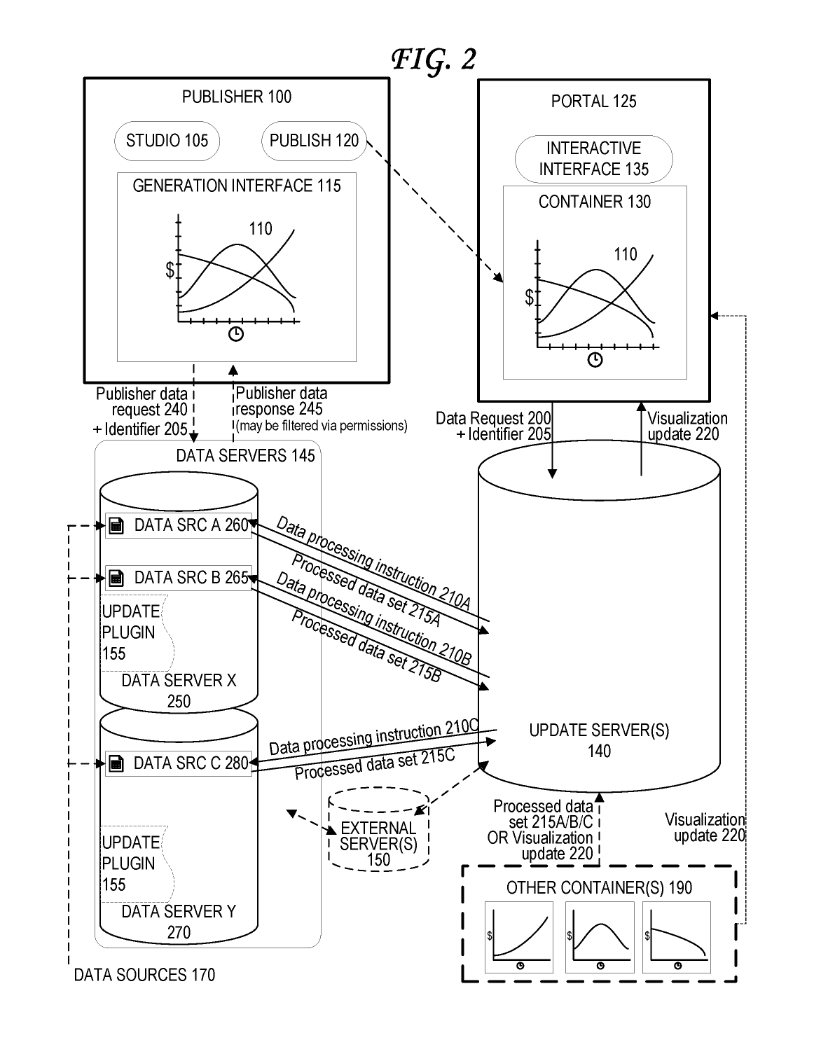

One or more security server(s) (not shown) may also be present, which may store permission data as described further in relation to FIG. 2.

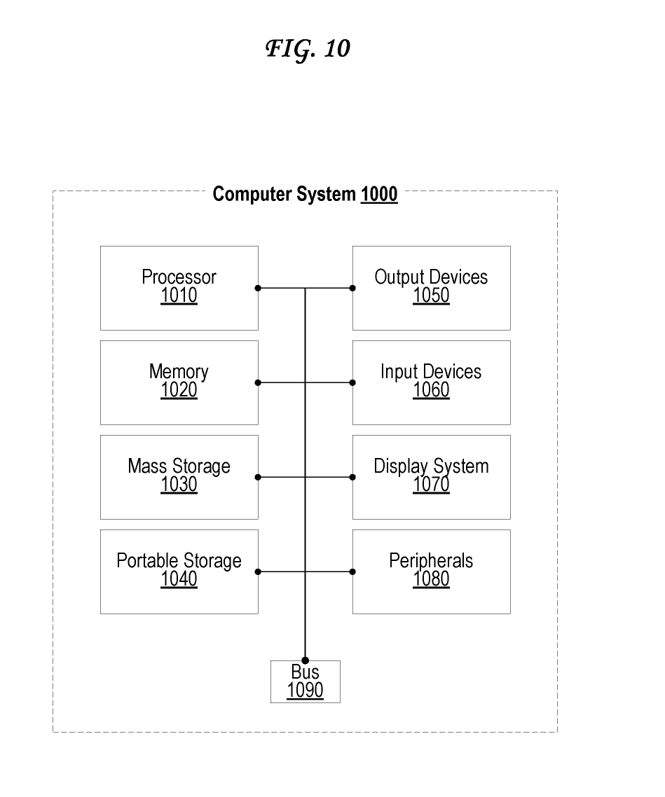

Each of the update server(s) 140, data server(s) 150, external server(s) 150, portal server(s), container server(s), security server(s), and viewer device(s) discussed may include at least one variant of computer system 1000 of FIG. 10, or may include at least some subset of the hardware components and software elements identified in FIG. 10. For example, each of the update server(s) 140, data server(s) 150, external server(s) 150, portal server(s), container server(s), security server(s), and viewer device(s) discussed may include one or more memory and/or data storage module(s) (e.g., which may include any kind of memory 1020, mass storage 1030, portable storage 1040, or some combination thereof), one or more processor(s) (e.g., processor 1010), one or more input mechanism(s) (e.g., one or more input devices 1060), one or more display screen(s) (e.g., such as display system 1070), or some combination thereof. Each of the update server(s) 140, data server(s) 150, external server(s) 150, portal server(s), container server(s), security server(s), and viewer device(s) discussed may include one or more such systems, which may be privately networked or distributed or some combination thereof, and which may include physical systems or virtual systems or some combination thereof.

The data server(s) 145 may store one or more data sources 170. Each data source of the data sources 170 may include any data structure that can hold data about one or more entities (e.g., database, a table, a list, a matrix, an array, an arraylist, a tree, a hash, a flat file, an image, a queue, a heap, a memory, a stack, a set of registers, or a similar data structure). Each data source of the one or more data sources 170 may be stored at a different subset of the data servers 145, or may be stored at the same subset as another data source. The data sources 170 may also be stored at least partly at the external server(s) 150.

Each data source of the data sources 170 may be associated with one or more Customer Relationship Management (CRM) systems, Information Management System (IMS), or other data management systems or services. For example, each of the data sources 170 may be associated with a Netsuite CRM system, a Salesforce CRM system, an SAP CRM System, an Oracle CRM system, a Microsoft Dynamics CRM system, a Zoho CRM system, an IBM IMS system, a Microsoft Sharepoint-based system, or another type of system for managing data. Each of the data sources 170 may also be associated with an ATOM feed, RSS feed, XML feed, or other type of updating data feed. In situations where multiple data sources 170 exist, each data source may be associated with a different type of CRM, IMS, or other data management system or service, or with a different type of data feed.

The data sources 170 may include one or more types of data, such as financial data, sports data, geographic data, time data, sales data, market research data, price data, currency exchange data, stock market data, film data, television data, video game data, device usage data, entertainment data, download data, viewership data, upload data, network data, network speed data, network coverage data, biological data, health data, hospital data, medical data, age data, height data, weight data, transportation data, traffic data, opinion data, voting data, political data, rating data, immigration data, emigration data, wealth data, poverty data, other types of data, or some combination thereof.

Data server(s) 145 may also be associated with various security measures, and data stored at data server(s) 145 may be encrypted. In embodiments where there is more than one data server(s) 145, data transmitted among the data server(s) 145 may be secured by keeping at least a subset of such data transmissions within a private/local network. Transmitted data may also be secured by using secure protocols such as Secure Sockets Layer (SSL) or Transport Layer Security (TLS).

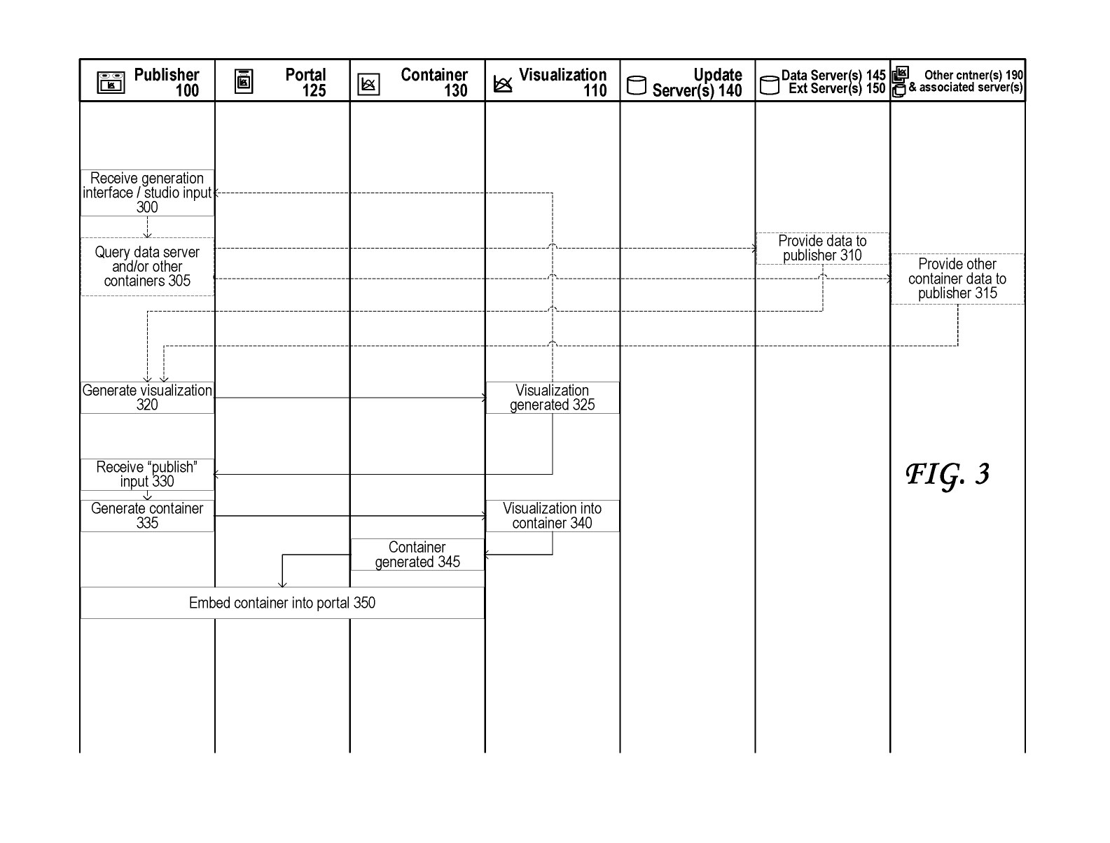

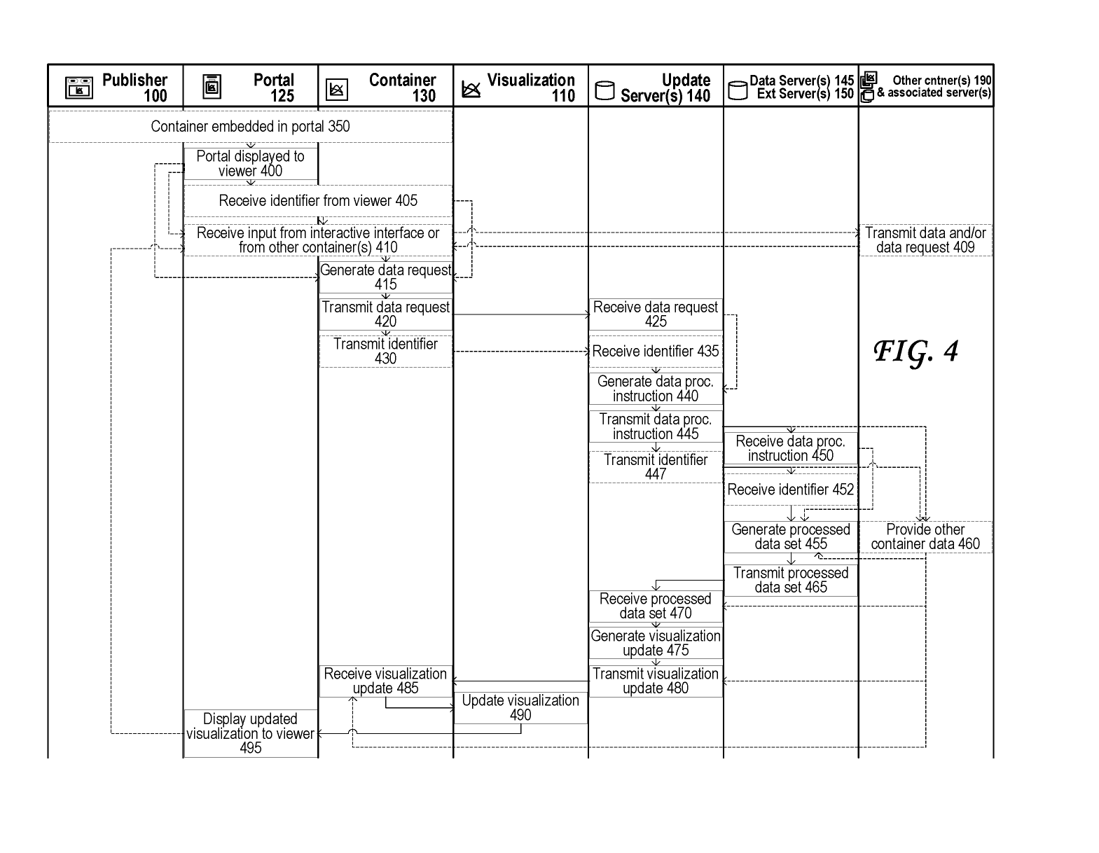

Each of the data server(s) 145, or a subset of the data server(s) 145, may also store and/or execute an update plugin 155. The update plugin 155 may be a piece of software stored in a data server memory 800 of the data server(s) 145 and executed by the processor(s) of the data server(s) 145. The update plugin 155 may be transferred to the data server(s) 145 and/or installed on the data server(s) 145 prior to any analytic visualization operations based on data from the data server(s) 145 (e.g., prior to the exemplary publishing operations of FIG. 3 and/or update operations of FIG. 4). In some embodiments, no update plugin 155 is necessary for the operations related to the present invention. The update plugin 155 may include an application program interface (API) that can be used by the update server(s) 140. Alternately, the update server(s) 140 may include an application program interface (API) of their own that can be used by the update plugin 155 and/or the data server(s) 145. The update plugin 155 and/or the data server(s) 145 may also facilitate data communications between the data server(s) 145 and the external server(s) 150.

In some embodiments, the update plugin 155 may be stored and/or executed at a different hardware device additionally or alternatively from the data server(s) 145, such as the external server(s) 150 or other hardware device(s) not pictured (e.g., such a hardware device may has access and/or control over files stored at the data server(s) 145). Such a device may optionally store a subset of the data sources 170.

External server(s) 150 may in some embodiments include one or more systems associated with large-scale data storage, data structures, and/or data queries. For example, external sever 150 may include one or more systems associated with a Google BigQuery system, a Google CloudSQL system, a Google BigTable system, an Amazon RedShift system, an Amazon DynamoDB system, a Microsoft Azure SQL system, an Amazon EC2-based system, an Google Compute-based system, a mapreduce-based system, a hadoop-based system, an Apache HBase-based system, a MongoDB-based system, or another type of system.

The portal 125 may be any type of web page or web-based interface. The portal 125 may be a public web page (or other web entity) accessible through the Internet or may be a private network portal accessible through a private network, such as a local area network (LAN), a wireless local area network (WLAN), a wired municipal area network (MAN), or a wide area network (WAN). Either way, the portal 125 may optionally be protected by security precautions (a login, a password, a PIN number, a security code/token such as RSA SecurID, a biometric scan, a digital key, or a digital certificate, or some combination thereof). The portal 125 may in some cases be associated with corporate or school intranets. The portal 125 may in some cases be associated with a CRM, IMS, or other data management system or service as described in relation to the data sources 170 (e.g., the portal 125 may be a Netsuite Portlet or a SalesForce Visualforce Page).

The portal 125 and/or container 130 and/or analytic visualization 110 and/or other container(s) 190 may be associated with a software application to be executed. For example, the portal 125 and/or container 130 and/or analytic visualization 110 may trigger the viewer device to open at least part of the portal 125 and/or container 130 and/or analytic visualization 110 in a separate software application, such as a video player software or a document reader/editor software, or a mobile device software “app.”

The portal 125 may include an embedded container 130. The container 130 may include an analytic visualization 110. The container 130 may be at least partly expressed as a string of text (or “code”), such as markup text, that may be inserted into a portal 125, which may be a HyperText Markup Language (HTML) page or an Extensible Markup Language (XML) page or some combination thereof. For example, the text/code for embedding the container 130 can include code corresponding to an “iframe” markup element, code corresponding to PHP Hypertext Preprocessor (PHP) elements, code corresponding to JavaScript (JS) elements, code corresponding to Cascading Style Sheet (CSS) elements, code corresponding to HTML Version 5 (HTML5) elements, code corresponding to HTML elements, code corresponding to XML elements, code corresponding to Extensible HTML (XHTML) elements, code corresponding to embedding an Adobe/MacroMedia Flash file, code corresponding to embedding a Microsoft Silverlight file, code corresponding to embedding a Java file, code corresponding to embedding a Microsoft ActiveX control or element, code corresponding to embedding an executable file, code corresponding to triggering a software application (e.g., a personal computer software suite such as an analytic visualization software or a video player software or a document reader/editor software, or a mobile device software “app”) stored on the viewer device, or other similar code capable of embedding or triggering interactive elements within a web page. The container 130 itself can include HTML, HTML5, XML, XHTML, CSS, JS, or some combination thereof, and can also include a multimedia container file such as an Adobe/MacroMedia Flash file, a Microsoft Silverlight file, a Java applet file, a Microsoft ActiveX control file, an executable file, or some combination thereof.

The container 130 may be associated with an interactive interface 135. The interactive interface 135 may be included within the container 130 or may be outside of the container 130 but tied to the container 130 such that any inputs received by the interactive interface 135 are received by the container 130. The interactive interface 135 may include a graphical user interface (GUI) with one or more GUI elements (e.g., icons, labels, push buttons, radio buttons, checkboxes, combination boxes, pop-up menus, pull-down menus, menu bars, tool bars, text entries, text areas, canvas panels, sliders, handles, or some combination thereof). The interactive interface 135 may also receive inputs from one or more hardware input devices, such as those described with regard to the input devices 1060 of FIG. 10. These GUI elements of the interactive interface 135 may be subdivided into sub-interfaces.

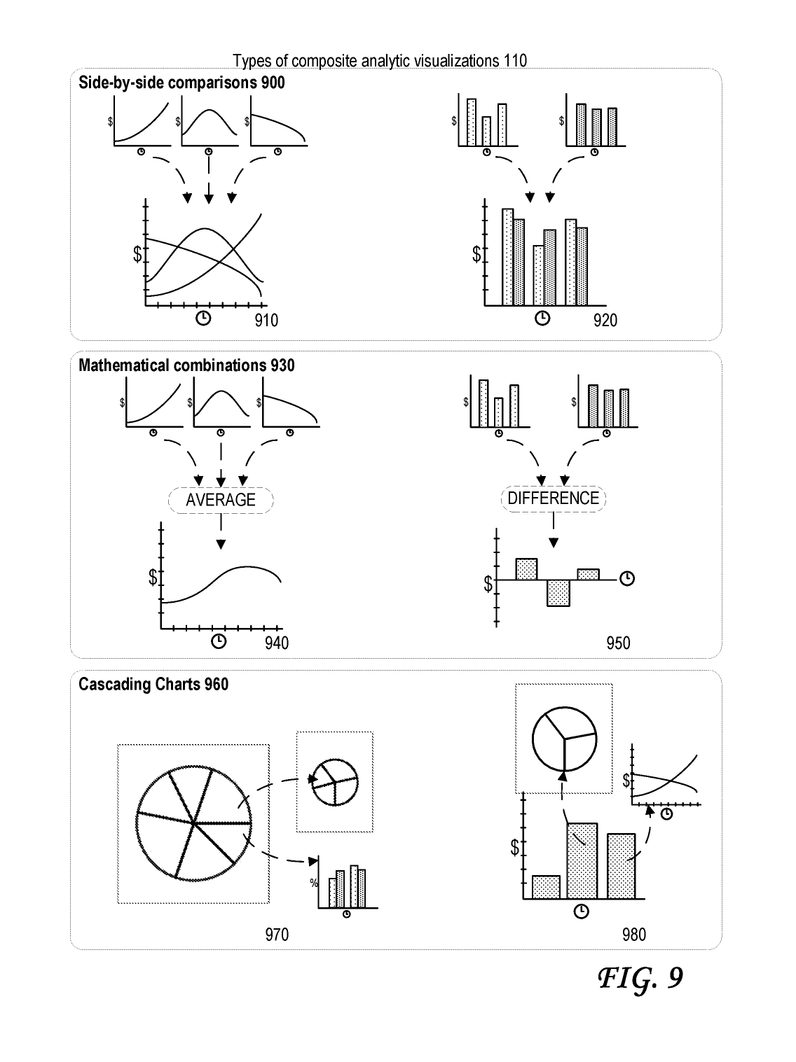

The interactive interface 135 may receive inputs from a viewer of the portal 125 related to the analytic visualization 110 displayed in the container 130. For example, a viewer may use the interactive interface 135 in order to request a filtering of the data in the analytic visualization 110 (e.g., to display sales data from only the United States if the analytic visualization 110 initially showed sales data worldwide). A viewer may use the interactive interface 135 in order to request a change of the data in the analytic visualization 110 (e.g., to display sales data from France if the analytic visualization 110 initially showed sales data from the United States). A viewer may use the interactive interface 135 in order to request a change in a display format of the analytic visualization 110 (e.g., to display sales data formatted as a pie chart if the analytic visualization 110 initially showed sales data formatted as a line graph) or a change in composite analytic visualization type (see FIG. 9). A viewer may use the interactive interface 135 in order to request two or more data sets (some of which may initially be displayed in one or more other containers 190), or two or more subsets of the same dataset, be compared either by displaying them side-by-side or by performing a mathematical operation (e.g., difference, sum, ratio, average) and displaying the result (e.g., to display difference data between sales data in the United States and sales data in France).

The analytic visualization 110 may be any type of visualization useful in analyzing data. For example, the analytic visualization 110 may be line graph, a bar chart, a pie chart, an area graph, a scatter plot, a volume graph, a surface graph, a doughnut chart, a bubble chart, a box plot, a radar chart, a sparkline chart, a cone chart, a pyramid chart, a stock chart, a histogram, a Gantt chart, a waterfall chart, a binary chart (e.g., win/loss), a pictograph, an organizational chart, a flow chart, a map, a gauge, a table, or another type of chart, graph, or indicator. The analytic visualization 110 may include data from the data sources 170, which may be stored at the data server(s) 145 and/or the external server(s) 150.

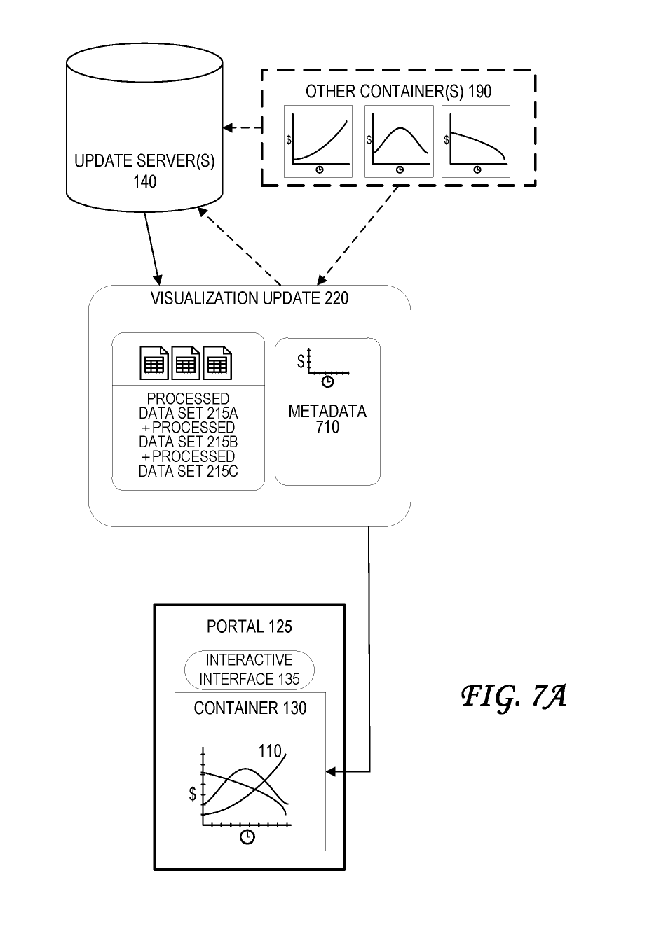

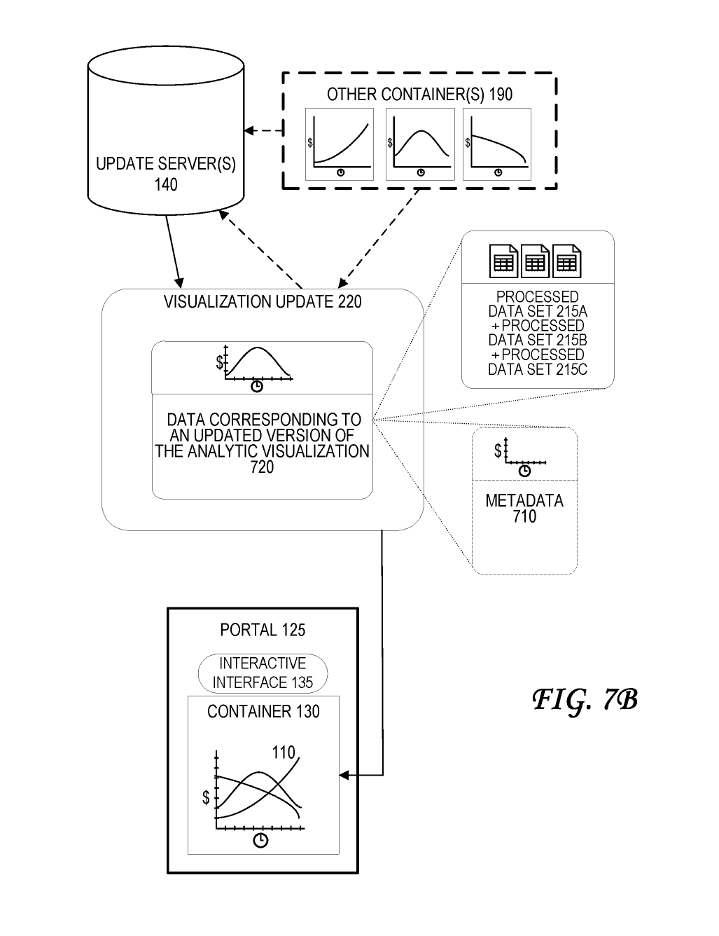

The analytic visualization 110 may also include metadata 510 (see FIG. 7A), which describes format, category, or dimension information related to the analytic visualization 110. For example, metadata 710 and may include graph axis information (e.g., the fact that the X axis of a graph displays time, cost, vote amounts, or some other category of data), format information (e.g., the fact that an analytic visualization is to be formatted as a line graph as opposed to a bar chart, and the fact that the line is to be three-dimensional and blue as opposed to two-dimensional and red), composite analytic visualization type information (e.g., the fact that a composite analytic visualization displays a ratio between data from a data source A 260 and a data source B 270; see e.g. FIG. 9). The metadata 710 may also include information about where a particular data source of the data sources 170 is stored (e.g., the fact that an analytic visualization is to use data from data source A 260 stored on data server X 250).

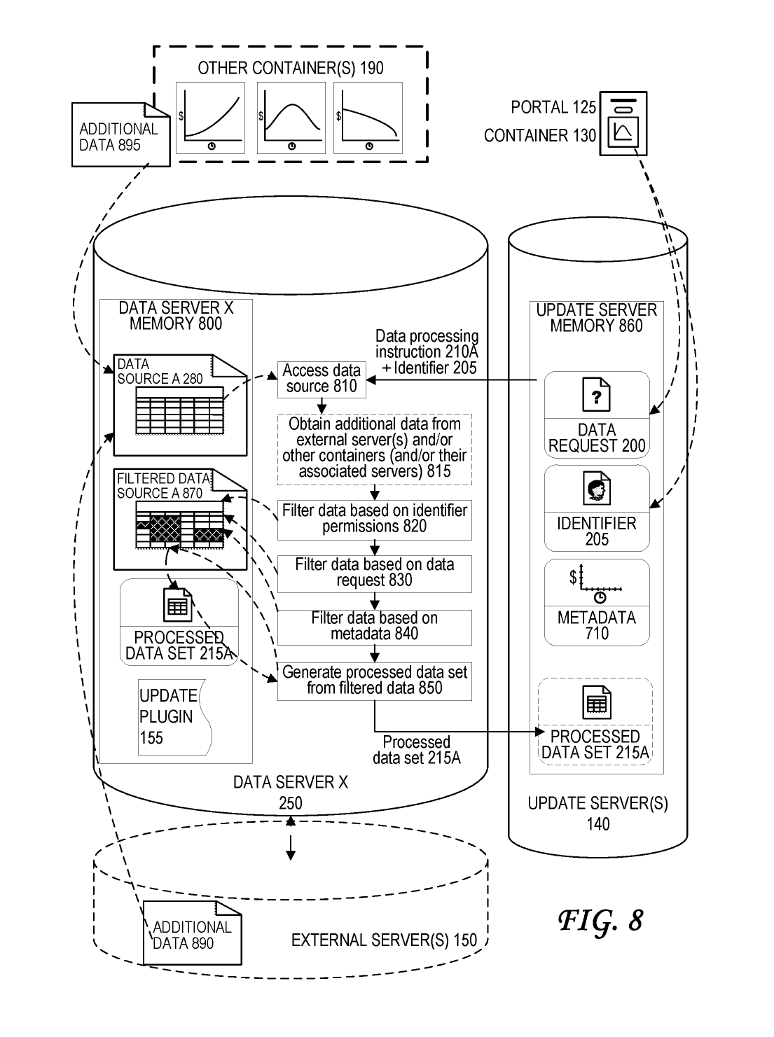

A publisher 100 may be used to generate, edit, and eventually publish the analytic visualization 110. The publisher 100 may include a studio interface 105, a publishing interface 120, and a generation interface 115. The studio interface 105 can include various GUI controls such as the ones described in relation to the interactive interface 135, and can be used to control the data to be used in the analytic visualization 110 to be published (e.g., data source A stored on data server X), the format of the analytic visualization 110 to be published (e.g., a line graph as opposed to a bar chart, with a three-dimensional blue line), the composite analytic visualization type of the composite analytic visualization 110 to be published (e.g., ratio between data from a data source A 260 and a data source B 270; see e.g. FIG. 9), and any software applications that are to be triggered in order to help display the analytic visualization 110 to a viewer (e.g., to open a particular part of the analytic visualization 110 in a video player application). The generation interface 115 may connect to the data sources 170 at the data server(s) 145 and/or external sever(s) 150 (e.g., through the update plugin 155) in order to provide data to preview the analytic visualization 110 to the user who is working to edit and publish the analytic visualization 110. In some situations, the user may not have permission to view all of the data from the data sources 170, in which case the data may be filtered before it is sent to the generation interface 115 based on permission settings associated with the user's identifier 205, similarly to the filtering/processing operations described in relation to FIG. 8. The user may then use the publishing interface 120 to generate a container 130 and control how the container 130 is generated, which may include generating container files, container embed codes, and container software triggers. The publisher 100 may in some cases alternately generate a portal 125 with the container 130 already embedded, or part of a portal 125 with the container 130 already embedded.

In an alternate embodiment (not shown), the generation interface 115 may instead transmit the publisher data request 240 (and identifier 205 if applicable) to the update server(s) 140, where the publisher data request 240 is then treated like a data request 200 (see e.g. FIG. 2, FIG. 4, and FIG. 8) with the exception that the resulting visualization update 220 is instead treated as the publisher data response 245 and is sent back to the generation interface 115 instead of to the container 130.

The analytic visualization ecosystem of FIG. 1 also includes one or more other container(s) 190. Each container of the other container(s) 190 is similar to the container 130, but may include an analytic visualization that shows different data than the data shown in the analytic visualization 110 of the container 130. Each container of the other container(s) 190 may display data from a subset of the data sources 170 that is different from a second subset of the data sources 170 displayed by the container 130 or yet another subset of the data sources 170 displayed by another container of the other containers 190. In some cases, certain containers may receive data from overlapping subsets of the data sources 170.

Each container of the one or more other container(s) 190 communicates with at least a subset of the one or more update server(s) 140, just as the container 130 does. These subsets may be distinct or they may be overlap. These subsets may in some cases communicate with each other. Some subsets may be connected via private networks while other subsets may be connected over the internet. Some subsets may be prohibited from communicating with certain other subsets.

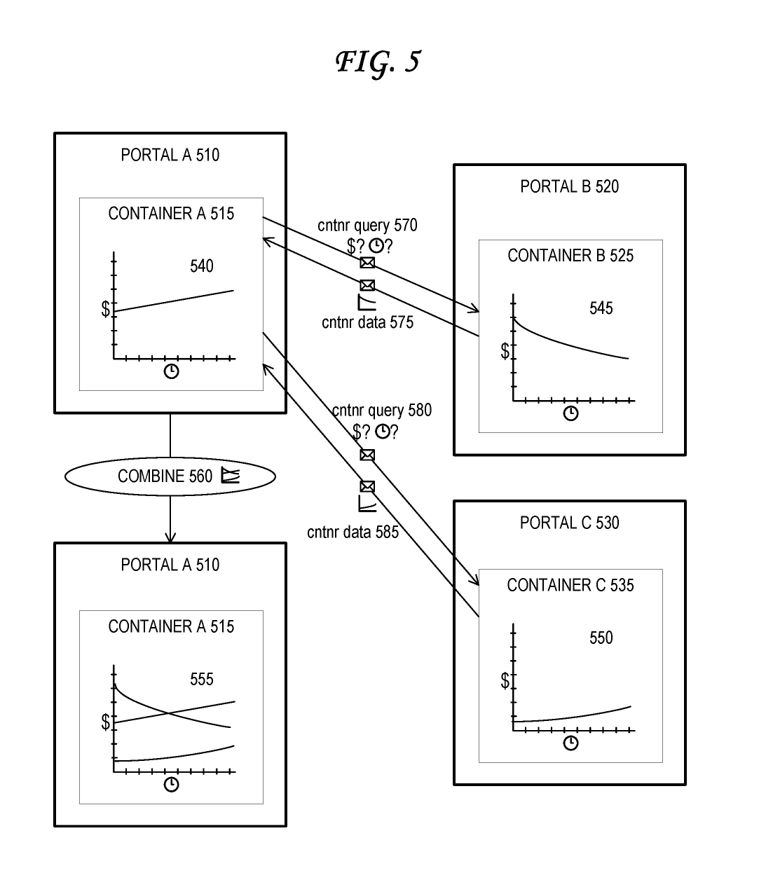

In some cases, containers 130/190 may be coaxed to share data between each other (e.g., see FIG. 5), which may take place at the container level—for instance, one container of the other containers 190 may transmit the data it has in its analytic visualization to the container 130, for example in the same format as a visualization update 220. Data sharing between containers 130/190 may also take place at the update server level—for example, an update server for a container of the other containers 190 may transmit a processed data set 215 or a visualization update 220 to an update server for the container 130. Data sharing between containers 130/190 may also take place at the data server level—for example, a data server transmits a processed data set 215 to an update server for a different container than the one it usually provides data to in response to one or more data processing instruction(s) received from one or more update server(s) associated with one or both of the containers involved. Data sharing between containers 130/190 may also take place at the external server level in a similar manner to the data server level, though optionally using one or more data server(s) as a proxy between the external server(s) 150 and the update server(s) 140. Data sharing between containers 130/190 may also take place using some combination of container-level sharing, update-server-level sharing, data-server level sharing, and external-server-level sharing.

FIG. 2 illustrates data transfers performed to update a composite analytic visualization within a container embedded in a portal. The data transfers of FIG. 2 illustrate update operations as well as optional publishing operations. FIG. 2 also illustrates an exemplary ecosystem with two data servers cumulatively storing three data sources.

The exemplary composite analytic visualization ecosystem of FIG. 2 illustrates the data servers 145 as including a data server X 250 with a data source A 260 and a data source B 265, as well as a data server Y 270 with a data source C 280. While both data server X 250 and data server Y 270 are illustrated as storing a copy of the update plugin 155, in some cases, only a subset of data servers in the set of data servers 145 store a copy of the update plugin 155 (e.g., in one embodiment, the data server X 250 stores a copy of update plugin 155 while the data server Y 270 does not). In some cases, none of the data servers 145 might store the update plugin 155, but rather, the data servers 145 could be managed by another hardware device (not shown) with functionality similar to the update plugin 155, which itself may or may not store a data source of the data sources 170.

In some cases, the different data sources of the data sources 170 may correspond to different containers. For example, the container 130 may use data source A 260 and a subset of data source C 280, while a second container (of the other containers 190) uses data source B 270, and while a third container (of the other containers 190) uses a second subset of data source C 280.

The optional publishing operations may begin with a publisher 100. A user of the publisher 100 may use the various GUI elements of the studio interface 105 to generate an analytic visualization 100 to be previewed at the generation interface 115. The generation interface 115 may connect to the data sources 170 (e.g., through the update plugin 155) in order to provide data for the analytic visualization 110 preview. This is illustrated as a publisher data request 240 from the generation interface 115 (e.g., at the publisher server) to the data servers 145, and a publisher data response 245 from the data servers 145 to the generation interface 115 (e.g., at the publisher server). In some situations, an identifier 205 (associated with the user using the publisher 100) may be sent alongside the publisher data request 240. The publisher data request 240 and identifier 205 could be sent together as part of a “bundle” of files. The bundle of files could be an archive file (including but not limited to file formats such as ZIP, RAR, 7Z, 7ZX, GZIP, TAR, BZIP2, CAB, LZH), a collection of multiple files sent in series (i.e., one after the other), a collection of multiple files sent in parallel (i.e., at least part of the transfer is performed simultaneously), or some combination thereof. The permission settings associated with the identifier 205 may be used to limit the data included in the publisher data response 245 in a similar manner to the one described regarding the filtering of the data source 260 before generating the processed data set 215A as described in FIG. 8. In this way, if a low-level employee is tasked with generating the analytic visualization 110 using the publisher 100, this does not mean that the low-level employee is automatically allowed to see data previewed through the generation interface 115 that the low-level employee would not be allowed to otherwise see (e.g., if the low-level employee tried to access this data through the analytic visualization 110 once it was already published), for example data that only high-ranking officers are authorized to view (e.g. employee payroll information).

Within the optional publishing operations, the identifier 205 may be gathered by the publisher 100 from the user automatically (e.g., by collecting a browser cookie when the user begins using the publisher 100), manually (e.g., by requiring an input by the viewer of a string, by requiring transmission of a file, or by requiring transmission of photographic/biometric data through the studio interface 105), or some combination thereof. The particular identifier 205 associated with a particular user of the publisher 100 may be associated with a set of permissions that dictate what data from the data sources 170 the particular user is allowed to preview via the publisher data response 240 in the same way that permissions associated with an identifier 205 of a viewer control dictate what data may be viewed by the viewer as described in FIG. 8.

The optional publishing operations may continue with the user then using the publishing interface 120 to generate a container 130 and control how the container 130 is generated, which may include generating container files, container embed codes, and container software triggers. The publisher 100 may in some cases alternately generate a portal 125 with the container 130 already embedded, or part of a portal 125 with the container 130 already embedded.

The update operations begin once the container 130 has been embedded in the portal 125, meaning that the analytic visualization 110 is “published” to viewers of the portal 125. In particular, once a viewer accesses the portal 125, and because it is embedded within the portal 125, the container 130, the container 130 (e.g., through the container server or portal server or viewer device) transmits a data request 200 to the update server(s) 140. In some cases, the container 130 also transmits an identifier 205 to the update server(s) 140. The data request 200 and identifier 205 could be sent together as part of a “bundle” of files. The bundle of files could be an archive file, a collection of multiple files sent in series, a collection of multiple files sent in parallel, or some combination thereof.

In some embodiments, the identifier 205 may be missing from this data transfer from the container 130 to the update server(s) 140, such as when the analytic visualization 110 is intended to show the same data regardless of who is viewing it (though an identifier 205 may still be sent in such a scenario for other purposes such as identifying who has viewed the analytic visualization 110). In such embodiments, the data transfer 200 is sent alone.

The data request 200 may be sent from the container 130 to the update server(s) 140 in one of several scenarios.

First, the data request 200 may be sent when a viewer first views the portal 125 using the viewer device (not displayed), in order to initially populate the analytic visualization 110 with data from the data sources 170. In some embodiments, this is not necessary, as the container 130 may already include some data gathered from the data sources 170 by the publisher 100 prior to publishing (e.g., using the publisher data request 240 and publisher data response 245). In other embodiments, it is may be necessary, particularly if an identifier 205 is sent alongside the data request 200, and if permission settings associated with the identifier 205 may affect what a viewer is allowed to see in the analytic visualization 110.

Second, the data request 200 may be sent in order to update the analytic visualization 110 when data is manipulated (e.g., new data is added or existing data is edited/deleted) at the data sources 170. Updates may be triggered automatically every time data is manipulated (e.g., new data is added or existing data is edited or deleted) at the data sources 170. Updates may alternately be triggered automatically every time relevant data (i.e., data that can be displayed by the analytic visualization 110 that is currently being displayed by the container 130) is manipulated at the data sources 170, while manipulation of irrelevant data (i.e., data that cannot be displayed by the analytic visualization 110 that is currently being displayed by the container 130) does not trigger an automatic update. Updates may alternately be triggered automatically when periodic polling (e.g., every 10 minutes) determines that data (or relevant data) has been manipulated at the data sources 170. Updates may alternately be triggered automatically periodically (e.g., every 10 minutes) regardless of whether or not data (or relevant data) has been manipulated at the data sources 170. Updates can also be triggered manually by the viewer (e.g., using the interactive interface 135 and/or a browser-based or operating-system-based interface).

Third, the data request 200 may be sent in response to an input from a viewer of the portal 125 (e.g., through the interactive interface 135). For example, a viewer may be able to trigger an input (e.g., through the interactive interface 135) in order to request a filtering of the data in the analytic visualization 110 as described in relation to the interactive interface 135 as depicted in FIG. 1. Some of these exemplary inputs may, in some cases, trigger a data request 200 in order to gather additional data or different data from the data sources 170. Some of these exemplary inputs may trigger actions that do not trigger a data request 200, such as when no additional data or different data is required from the data sources 170.

A viewer of the portal 125 may be also able to trigger an input (e.g., through the interactive interface 135) in order to request a change in a display format of the analytic visualization 110 (e.g., to display sales data formatted as a pie chart if the analytic visualization 110 initially showed sales data formatted as a line graph) or of composite analytic visualization type of the composite analytic visualization 110 (e.g., to display an average of data from two data sources instead of displaying them side-by-side). Some of these exemplary inputs may, in some cases, trigger a data request 200 in order to gather additional data or different data from the data sources 170 (e.g., if the new format is more detailed and thus requires more data than the previous format). Some of these exemplary inputs may trigger actions that do not trigger a data request 200, such as when no additional data or different data is required from the data sources 170 (e.g., if the new format is equally detailed or less detailed and thus does not require more data than the previous format).

There may also be other scenarios in which a data request 200 is sent from the container 130 to the update server(s) 140. For example, a data request 200 might be sent in response to a communication from another computing device (not pictured).

The identifier 205 may include one or more of a variety of types of identity-related files or data types. The identifier 205 may be or include, for example, an OAuth token, a browser cookie, a symmetric key, a public key, a temporary security token, a certificate signed by a certificate authority, a Lightweight Directory Access Protocol (LDAP) token, a Remote Authentication Dial In User Service (RADIUS) token, a Security Assertion Markup Language (SAML) token, an Active Directory token, an XML-based token, a data set including at least one user-specific descriptor, or some combination thereof. The identifier 205 may include a variety of data types, such as a name, a username, a user account, a telephone number, an email address, a password, a PIN number, a social security number, a driver's license number, an identification number, a biometric dataset, a user-specific code, a user-specific barcode, a user-specific icon, an image, an identifying trait, or some combination thereof. The identifier 205 may be gathered from the viewer automatically (e.g., by collecting a browser cookie when the viewer visits the portal 125), manually (e.g., by requiring an input by the viewer of a text string, by requiring transmission of a file, or by requiring transmission of photographic/biometric data), or some combination thereof. The identifier 205 may be collected by the portal 125 and/or the container 130 and/or the interactive interface 135.

The particular identifier 205 associated with a particular viewer may be associated with a set of permissions that dictate what data from the data sources 170 of the data servers 145 and/or external server(s) 150 the particular viewer is allowed to access. For example, if the data sources 170 hold sales data for a company, and the analytic visualization 110 is a sales visualization, different members of the company might have different permissions allowing them to view different data in the analytic visualization 110. For instance, a high-ranking company executive of the company may be granted access to all of the worldwide sales data in the data sources 170, while a regional manager might be granted access to only the regional sales data from the data sources 170 associated with that regional manager's managed region (e.g. California, Virginia, New York, Washington D.C.). Low-level employees may further be granted limited access to sales data from the data sources 170 through the analytic visualization 110 (e.g., only yearly sales sums rather than detailed reports), and members of the public may be completely barred from access to any sales data through the analytic visualization 110. All of this may be controlled by permission settings associated with the identifier 205. The permission settings are generally obtained by the portal server and/or container server and sent to the update server(s) 140 and eventually the data servers 145. In some embodiments, the permission settings may also be accessible at the publisher device and/or the external server(s) 150.

The permission settings associated with an identifier 205 may be sent alongside the identifier 205 (or one after the other). For example, the permission settings could be part of the identifier 205 (e.g., part of a file sent representing the identifier 205 or part of a string sent representing the identifier 205). The permission settings and identifier 205 could be sent together as part of a “bundle” of files. The bundle of files could be an archive file, a collection of multiple files sent in series, a collection of multiple files sent in parallel, or some combination thereof.

The permission settings may alternately be stored separately from the identifier in a location where they may be accessed by the data servers 145 and/or the external server(s) 155 and/or the update server(s) 140 (e.g., through a network connection). For example, the permission settings may be stored by separate security server(s) (not pictured) that may be queried by one or more of the data servers 145 and/or the external server(s) 155 and/or the update server(s) 140 and/or the portal server and/or the container server and/or the viewer device. The security server(s) may alternately be the same computing device(s) as one or more of the data servers 145, the external server(s) 155, the update server(s) 140, portal server (not pictured), container server (not pictured), and/or the publisher device (not pictured). The security server(s) may be run by a trusted third party such as a certificate authority.

Once the update server(s) 140 (or a subset thereof) receive the data request 200 (and, in some cases, also the identifier 205), the update server(s) 140 (or a subset thereof) may conduct operations in order to eventually generate the visualization update 220. In particular, the update server(s) 140 (or a subset thereof) may generate one or more data processing instructions, transmit these data processing instructions to the data servers 145, and then receive one or more processed data sets, each processed data set corresponding to a data processing instruction.

In the ecosystem of FIG. 2, the update server(s) 140 are illustrated transmitting one data processing instruction per data source (of the data sources 170), and receiving one processed data set per data source (of the data sources 170). In particular, the update server(s) 140 are illustrated transmitting data processing instruction 210A to data source A 220, and the data server X 200 is illustrated transmitting processed data set 215A back to the update server(s) 140. The update server(s) 140 are illustrated transmitting data processing instruction 210B to data source B 230, and the data server X 200 is illustrated transmitting processed data set 215B back to the update server(s) 140. The update server(s) 140 are illustrated transmitting data processing instruction 210C to data source C 240, and the data server Y 210 is illustrated transmitting processed data set 215C back to the update server(s) 140. The processing operations executed by the data servers 145 in order to generate the processed data sets are described in more detail in FIG. 8, which illustrates, as an example, data server X 250 generating processed data set 215A based on data processing instruction 210A and an identifier 205. These processing operations may be guided or facilitated by the update plugin 155. During these processing operations, the data servers 145 may in some cases obtain more data from the external server(s) 150 as needed.

The identifier 205 may also be sent to the data servers 145 along with each data processing instruction. Each data processing instruction and identifier 205 could be sent together as part of a “bundle” of files. The bundle of files could be an archive file, a collection of multiple files sent in series, a collection of multiple files sent in parallel, or some combination thereof.

The update server(s) 140 may, in some situations, send one or more of the data processing instructions (210A-C in the ecosystem of FIG. 2) (and identifier 205 where applicable) to the external server(s) 150 as an intermediary, so that the external server(s) 150 may then forward the data processing instruction 210 and/or the identifier 205 onward to the data servers 145.

Each processed data set includes at least a subset of data from the data source to which its associated data processing instruction was sent. For instance, processed data set 215A includes at least a subset of data from data source A 260, to which data processing instruction 210A was sent. This subset includes the data that is requested by the analytic visualization 110, that the permission settings associated with the identifier 205 allow to be shown, and that should be obtained given the type/format of the composite analytic visualization 110. The fact that the data servers 145, not the update server(s) 140, perform the operations for generating each processed data set gives the present invention a security benefit, since sensitive data from the data sources 170 that is not within a processed data set does not need to travel over the public Internet.

Once the data servers 145 have generated the processed data sets, the data servers 145 transmit the processed data sets to the update server(s) 140. The update server(s) 145 then generate a visualization update 220 based on the processed data sets. In one embodiment, update server(s) 140 may also combine processed data set 215A, processed data set 215B, and processed data set 215C into a single “combined” processed data set on which to base the visualization update 260. Regardless of whether or not a “combined” processed data set was generated, the update server(s) 140 then transmit the visualization update to the container 130.

The visualization update 220 may take one of at least two forms, depending on where the analytic visualization 110 is to be generated.

The first form of the visualization update 220 may include the processed data sets (or a “combined” processed data set) and metadata 510 stored at the update server(s) 140. Using this form of visualization update 220, the container 130 receives the visualization update 220 and uses the processed data sets (or a “combined” processed data set) and metadata 510 to generate an updated version of the analytic visualization 110. This first form of the visualization update 220 may be useful to put less stress on the update server(s) 140. This first form of the visualization update 220 is further described in FIG. 7A.

The second form of the visualization update 220 may include data corresponding to an updated version of the analytic visualization 110. Update server(s) 140 that use this form of visualization update 220 use the processed data sets (or a “combined” processed data set) and metadata 510 to generate the data corresponding to an updated version of the analytic visualization 110. Once the container 130 receives the visualization update 220, it simply displays the updated version of the analytic visualization 110 based on the data corresponding to the updated version of the analytic visualization 110 that was already generated by the update server(s) 140. This second form of the visualization update 220 may be useful when generating an updated version of the analytic visualization 110 is particularly resource-intensive. This second form of the visualization update 220 is further described in FIG. 7B.

Once the container 130 receives the visualization update 220, it may generate and/or display the updated version of the analytic visualization 110 as described above.

The ecosystem of FIG. 2 also includes the other container(s) 190 illustrated in FIG. 1. As in FIG. 1, each container of the one or more other container(s) 190 communicates with at least a subset of the one or more update server(s) 140, just as the container 130 does. These subsets may be distinct or they may be overlap. These subsets may in some cases communicate with each other, for instance when a container of the other containers 190 is coaxed into sharing data with the container 130. Some subsets of the one or more update server(s) 140 may be connected (e.g., to containers 130/190, to data servers 140, to external servers 150, or to each other) via private networks while other subsets may be connected (e.g., to containers 130/190, to data servers 140, to external servers 150, or to each other) over the internet. Some subsets of the one or more update server(s) 140 may be prohibited from communicating with certain other subsets of the one or more update server(s) 140.

In some cases, containers 130/190 may be coaxed to share data between each other (e.g., see FIG. 5), which may take place at the container level—for instance, one container of the other containers 190 may transmit the data it has in its analytic visualization to the container 130, for example in the same format as a visualization update 220. Data sharing between containers 130/190 may also take place at the update server level—for example, an update server for a container of the other containers 190 may transmit a processed data set 215 or a visualization update 220 to an update server for the container 130. Data sharing between containers 130/190 may also take place at the data server level—for example, a data server transmits a processed data set 215 to an update server for a different container than the one it usually provides data to in response to one or more data processing instruction(s) received from one or more update server(s) associated with one or both of the containers involved. Data sharing between containers 130/190 may also take place at the external server level in a similar manner to the data server level, though optionally using one or more data server(s) as a proxy between the external server(s) 150 and the update server(s) 140. Data sharing between containers 130/190 may also take place using some combination of container-level sharing, update-server-level sharing, data-server level sharing, and external-server-level sharing.

FIG. 3 is a lane-based flow diagram illustrating the publishing of an exemplary composite analytic visualization within a container embedded in a portal. The publishing operations are optional in relation to the updating operations described in FIG. 4, and in some cases different publication operations can be used.

The exemplary publication operations depicted in FIG. 3 begin with receipt of inputs from the studio interface 105 and/or generation interface 115 of the publisher 100 (step 300). These input may correspond to a user's interactions with the studio interface 105 and/or generation interface 115.

Optionally, the publisher 100 may query the data server(s) 145 and/or the external server(s) 150 and/or the other containers 190 and their associated server(s) (e.g., update servers 140 and/or data servers 145 and/or external servers 150 associated with the other containers 190) through the publisher data request 240 (step 305). The data server(s) 145 may then gather a subset of the data from at least a subset of the data sources 170 that are stored within the data server(s) 145 and/or the external server(s) 150, and may subsequently provide this data back to the publisher 100 in the form of the publisher data 245 as described in relation to FIG. 2 (step 310). The other container(s) 190 and/or their associated servers may also provide data in the form of publisher data 245 from one or more of the server(s) associated with the other container(s) 190 to the publisher 100 (step 315). In some embodiments, the publisher data response 245 may be filtered at the data server(s) 145 or at the server(s) associated with the other container(s) 190 based on the publisher user's permissions as described in relation to FIG. 2.

The publisher 100 may then generate a visualization 110 (step 320, step 325). The previously discussed steps may be repeated if the user makes further edits to the visualization (e.g., by receiving visualization studio input from the studio interface 105 and/or generation interface 115 at step 300).

Once a visualization is generated (see step 320 and step 325), the publisher may receive a “publish” input from the publish interface 120 of the publisher 100 (step 330). The “publish” input may indicate that the user wishes to “publish” the analytic visualization 110 by generating a container 130 for the analytic visualization 110 and embedding it into a portal 125. The “publish” input could in some cases be an automatic input instead of a manual input triggered by a user—for example, the publisher 100 could be programmed to automatically generate and publish a new analytic visualization every time a new category of data, or a new data source, is added to data sources 170.

Once the publisher receives the “publish” input (see step 330), the publisher 100 generates a container 130 (step 335). The container 130 is generated so that the analytic visualization 110 generated at the publisher 110 can be displayed by the container 130 (step 340), thus completing generation of the container 130 (step 345).

Once the container 130 is generated (see step 345), the container 130 may be embedded into the portal 125, either automatically via actions taken by the publisher 100, or manually via actions taken by a user. For example, the publisher 100 may output code corresponding to the generated container 130, which a user may copy and paste into the markup code (e.g., HTML) of a web page that is being used as the portal 125. Alternately, the publisher 100 may automatically embed the container 130 into the portal 125 (see step 350) through by being granted some degree of access to one or more files stored at the portal server (not pictured). and/or container server (not pictured).

FIG. 4 is a lane-based flow diagram illustrating the updating of a composite analytic visualization within a container embedded in a portal.

The update operations may begin with the portal 125 being displayed to a viewer who is accessing the portal 125 using a viewing device (step 400). The accessing of the portal 125 by the viewer may optionally take place immediately after the container 130 is first embedded in the portal 125 (step 350 of FIG. 4; see also step 350 of FIG. 3), though this is not a requirement.

The portal 125 and/or container 130 may, in some situations, receive an identifier 205 from the viewer (step 405), either through automatic collection of the identifier 205 by the portal 125 and/or the container 130 (e.g., such as if the identifier 205 is a browser cookie) or through manual transmission of an identifier 205 (e.g., such as if the identifier 205 is a password or biometric dataset) to the portal 125 and/or the container 130.

The portal 125 and/or container 130 may, in some situations, receive an input from interactive interface 135 and/or from one or more of the other container(s) 190 (and/or from servers associated with the other containers 190) (step 410). Using the interactive interface 135, a viewer may trigger one of a number of different types of data requests relating to viewer-controlled manipulation of the analytic visualization 110. For example, a viewer may trigger an input (e.g., through the interactive interface 135) that requests a filtering of the data to be displayed in the analytic visualization 110 as described in relation to the interactive interface 135 depicted in FIG. 1. The viewer may also trigger an input that requests data from one or more of the other container(s) 190 and/or their associated server(s) (e.g., update servers 140 and/or data servers 145 and/or external servers 150 associated with the other containers 190), which may be followed by receipt of data from the other container(s) 190 and/or their associated server(s) (step 409). In some cases, receipt of data from the other container(s) 190 and/or their associated server(s) may occur (steps 409 and 410) unprompted by inputs to the interactive interface 135. (step 410)

The next step of the update operations, regardless of whether the identifier 205 was received (see step 405) and/or the input from the interactive interface 135 and/or the other container(s) 190 (and/or their associated servers) was received (see step 410), is for the container 130 to generate a data request 200 (step 415). The data request 200 may include a request to update, change, and/or add to the visualization data in the analytic visualization 110 using data from the data sources 170. The data request 200 may also include a request to change the format of the analytic visualization 110, or a change in composite analytic visualization type (see FIG. 9). The data request 200 may also include a request to populate the analytic visualization 110 with data from the data sources 170 for the first time.

The container 130 and/or portal 125 may then transmit the data request 200 to the update server(s) 140 (step 420), after which the update server(s) 140 may receive the data request 200 (step 425). If the portal 125 and/or container 130 received an identifier 205 from the viewer at step 405, the container 130 may also transmit the identifier 205 to the update server(s) 140 (step 430), after which the update server(s) 140 may receive the identifier 205 (step 435).

Once the update server(s) 140 have received the data request 200 (see step 425), and in some embodiments, also the identifier 205 (see step 435), the update server(s) 140 may generate one or more data processing instructions, one for each data source (step 440). The data processing instruction 210 may include any instructions necessary/useful for the data server(s) 145 to obtain the desired visualization data requested by the data request 200 from the data sources 170. The data processing instruction 210 may, for example, identify metadata 510, as well as requested data sets, categories, or sources, manipulate which data is used, identify filters that determine what data should not be included, or other similar information.

Once the update server(s) 140 generates the data processing instruction 210 (see step 440), the update server(s) 140 may transmit each data processing instruction to the data server(s) 145 (step 445) so that each data server receives one data processing instruction per data source on the data server. The data server(s) 145 may then receive the data processing instructions (step 450). If the portal 125 and/or container 130 received an identifier 205 from the viewer at step 405, the update server(s) 140 may also transmit the identifier 205 to the data server(s) 145 and/or the external server(s) 150 (step 447), after which the update server(s) 140 may receive the identifier 205 (step 452).

Once the data server(s) 145 and/or the external server(s) 150 receive the data processing instructions (see step 450), and, in some cases, the identifier 205 (see step 452), the data server(s) 145 and/or the external server(s) 150 may access the data sources 170 and generate a processed data set for every data processing instruction (step 455). Generating each processed data set may be based on the data request 200, the analytic visualization metadata 510 (which stores information including the format of the analytic visualization 110, the composite analytic visualization type, and axes and categories of data included within the composite analytic visualization), and the identifier 205. The processing operations executed by the data server(s) 145 and/or the external server(s) 150 in order to generate the processed data sets are described in more detail in FIG. 8. These processing operations may be guided or facilitated by the update plugin 155.

In some cases, update operations may also retrieve data from the one or more other container(s) 190 and/or their associated server(s) (e.g., one or more update servers 140 and/or one or more data servers 145 and/or one or more external servers 150 associated with the other containers 190) (step 460). These other container(s) 190 and/or their associated server(s) may be sent data requests 200, data processing instructions 210, a container-to-container communication, or some combination thereof, depending on which elements are communicating with each other. The other container(s) 190 and/or their associated server(s) may optionally receive an identifier 205. Step 460 may be preceded by step 445, step 447, step 450, or step 452. Step 460 may lead to step 455, 465, 470, 480, or 485, since the data from the other container(s) 190 and/or their associated server(s) may be sent to the data server(s) 145 associated with the container 130 (e.g., as a processed data set 215) or may be sent to the update server(s) 140 associated with the container 130 (e.g., as a processed data set 215 or as a visualization update 220) or may be sent directly to the container 130 (e.g., as a visualization update 220). In some cases, the container data step of 460 may be disjointed from the remainder of the update operations of FIG. 4, which may continue alongside the transmission of the data from the other container(s) 190 and/or their associated server(s).

The processed data set(s) generated at step 455 include at least a subset of data from the data source(s) (of data sources 170) toward which their associated data processing instructions were sent. This subset includes the data that is requested by the analytic visualization 110, that the permission settings associated with the identifier 205 allow to be shown, and that should be obtained given the type/format of the analytic visualization. The fact that the data server(s) 145, not the update server(s) 140, perform the operations for generating the processed data set 215 gives the present invention a security benefit, since sensitive data from the data sources 170 that is not within the processed data sets does not need to travel over the public Internet.

Once the data server(s) 145 generate the processed data sets 215 at step 455 (with or without data from the external servers 150 and/or the other container 190 and/or their associated servers), the data server(s) 145 may transmit the processed data sets 215 to the update server(s) 140 (step 465), after which the update server(s) 140 may receive the processed data sets 215 (step 470). The update server(s) 140 may then generate a visualization update 220 based on the processed data sets 215 (step 475).

The visualization update 220 may take one of at least two forms, depending on where the analytic visualization 110 is to be generated. These two forms are illustrated and described in FIG. 7A and FIG. 7B and the related descriptions, as well as the description of the visualization update 220 in FIG. 2. Once the update server(s) 145 generates the visualization update 220, the update server(s) 145 may then transmit the visualization update 220 to the container 130 (step 480), after which the container 130 may receive the visualization update 220 (step 485). The container 130 may then update the analytic visualization 110 based on the visualization update 220 (step 490).

If the visualization update 220 is of the first type as depicted in FIG. 7A (including the processed data sets and metadata 510), then updating the analytic visualization 110 based on the visualization update 220 may involve generating the updated version of the analytic visualization 110 based on the processed data sets and metadata 510. If the visualization update 220 is of the second type as depicted in FIG. 7B (including data corresponding to an updated version of the analytic visualization 520), then updating the analytic visualization 110 based on the visualization update 220 may involve simply displaying the updated version of the analytic visualization 110 whose corresponding data is already included in the visualization update 220.

Once an updated version of the analytic visualization 110 has been generated and the analytic visualization 110 has been updated (see step 490), the updated version of the analytic visualization 110 may be displayed to the viewer (step 495). The viewer may then view and interact with the analytic visualization 110 (e.g., through the interactive interface 135). If the viewer's interaction with the interactive interface 135 requires additional and/or different data to be loaded from the data server(s) 145 and/or external server(s) 150, then the update operations may repeat starting from step 410.

The operations described herein as being performed by the container 130 be executed by the viewer device, the container server, the portal server, or some combination thereof.

FIG. 5 illustrates three intelligent containers communicating with each other. In particular, FIG. 5 illustrates a portal A 510 including a container A 515 with an analytic visualization 540, a portal B 520 including a container B 525 with an analytic visualization 545, and a portal C 530 including a container C 535 with an analytic visualization 550.

Container A 515 or one of its associated servers (e.g., an update server 140, data server 145, external server 150 or some combination thereof associated with container A 515) may transmit a container query 570 to the container B 525 or one of its associated servers (e.g., an update server 140, data server 145, external server 150 or some combination thereof associated with container B 525) and receive a container dataset 575 (e.g., including at least some of the visualization data 545 from container B 525) in return. The container query 570 may be used to determine whether at least some of the visualization data 545 from container B 525 can be combined or compared in a meaningful way with at least some of the visualization data 540 from container A, for example by determining whether both share at least one graph dimension/axis unit type (e.g., time, currency amount, number of sales, number of votes, temperature, speed, velocity, or any of the other unit types identified with respect to FIG. 1) or whether one or more of the graph dimensions/axes may be mapped to a shared unit type (e.g., by converting currency types, by converting temperature units, by calculating speed measurements using time and distance measurements, by calculating batting averages using multiple data points). Such mapping may be performed according to previously-defined automatic rules (e.g., for direct mappings such as temperature unit conversions) or by previously-defined user-based rules (e.g., for mappings that require multiple steps such as calculating batting averages using multiple data points or calculating speed measurements using time and distance measurements), or by rules using some combination thereof.

Container A 515 or one of its associated servers (e.g., a container server, an update server 140, a data server 145, an external server 150, or some combination thereof associated with container A 515) may also transmit a container query 580 to the container C 535 or one of its associated servers (e.g., a container server, an update server 140, a data server 145, an external server 150, or some combination thereof associated with container C 535) and receive a container dataset 585 (e.g., including at least some of the visualization data 550 from container C 535) in return. The container query 580, similarly to the container query 570, may be used to determine whether at least some of the visualization data 550 from container C 535 can be combined or compared in a meaningful way with at least some of the visualization data 540 from container A.

Once the container A 515 or one of its associated servers (e.g., a container server, an update server 140, a data server 145, an external server 150 or some combination thereof associated with container A 515) receives the container data 570 and the container data 580, a combination step 560 may be performed (e.g., by the container A 515 itself or by one of its associated servers) to combine the data from the visualization 540 of the container A 515 with the container data 570 and the container data 580. After the combination step 560, the container A 515 may display an updated analytic visualization 555 that illustrates a combination or comparison of these data sets, which may be combined or compared as seen in FIG. 9.

While the different containers of FIG. 5 are illustrated as each being embedded into a different portal, this need not be the case. One portal may include any number of embedded containers, so any two of the containers of FIG. 5, or all three of the containers of FIG. 5, could be embedded into a shared portal.

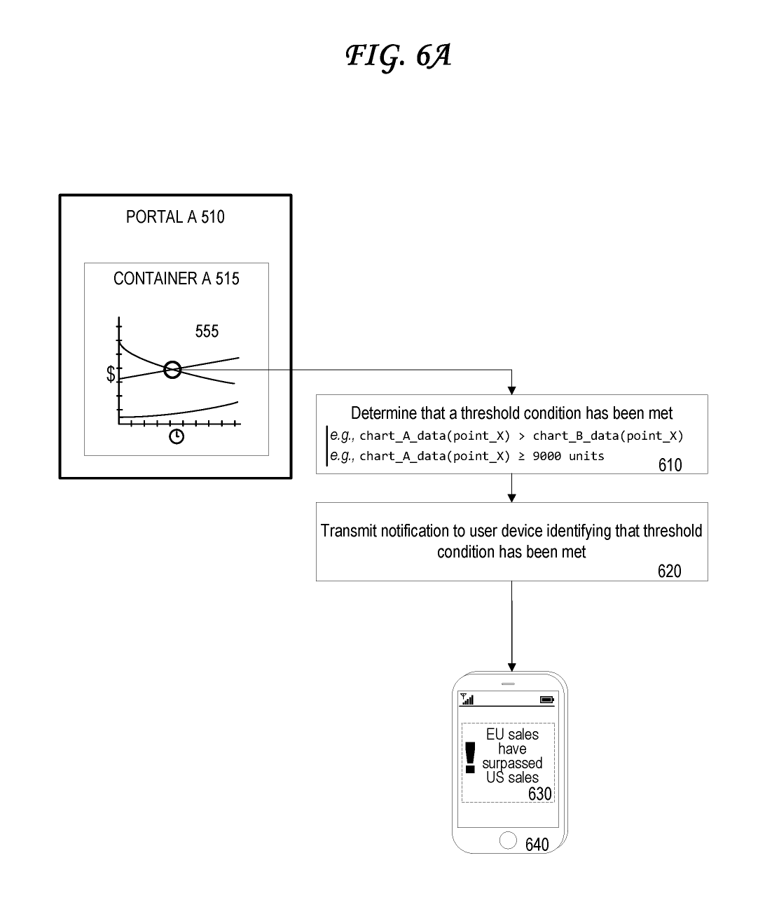

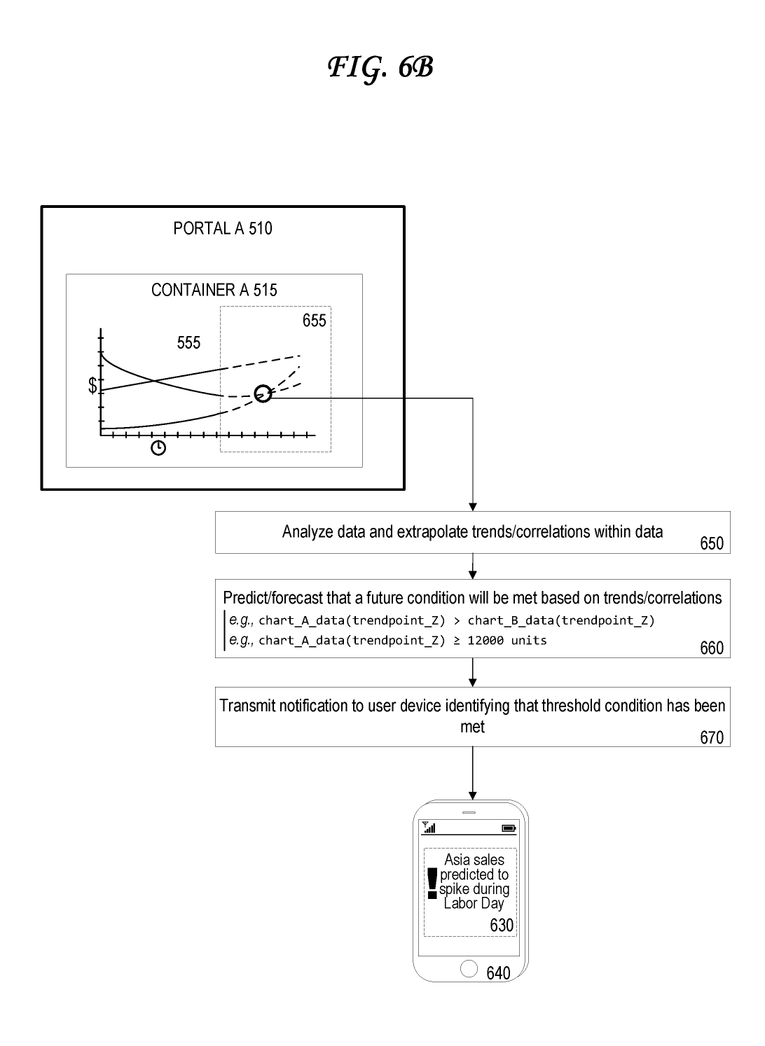

FIG. 6A is a flow diagram illustrating user device notifications based on container chart data. In particular, the container of FIG. 6A is the container A 515 of FIG. 5 after the combination step 560 has been performed, with the updated analytic visualization 555 displayed. In other embodiments, a different container 130 may be used.

At a step 610, the container A 515 or one of its associated servers determines that a threshold condition has been met. The threshold condition may be a relative threshold condition; for example, the threshold condition may be that data originally from a data source A 260 is greater than data originally from a data source B 265 at a certain point, or that data originally from a container A 515 visualization data set 540 is greater than data originally from a container B 525 visualization data set 545 at a certain point. The condition can also simply be an indication of anomalous behavior—for example, that data associated with a particular data source suddenly has values that are more than a particular threshold number of standard deviations away from an average value, or that are breaking away from a trend.

The threshold condition of step 610 may be an absolute threshold condition; for example, the threshold condition may be that a certain graph line within the updated analytic visualization 555 is greater than (“>”), greater than or equal to (“≧”), less than (“<”), less than or equal to (“≦”), or equal to (“=”) a certain predetermined amount (measured in appropriate units). In the example of FIG. 6A, step 610 identifies an example of an absolute threshold condition, namely that a point along “chart_A” at a “point_X” along the time axis being greater than or equal to (“≧”) an absolute amount, namely 9000 units.

The threshold condition of step 610 may alternately be a relative threshold condition; for example, the threshold condition may be that a first point on a first graph line within the updated analytic visualization 555 that corresponds to an point on an axis is greater than (“>”), greater than or equal to (“≧”), less than (“<”), less than or equal to (“≦”), or equal to (“=”) a second point on a second graph line within the updated analytic visualization 555 corresponding to that point on the axis. In the example of FIG. 6A, step 610 identifies an example of a relative threshold condition, namely that a first point along “chart_A” at a “point_X” along the time axis being greater than (“>”) a second point along “chart_B” at the “point_X” along the time axis.

Once the threshold condition is determined to have been met at step 610, then at step 620, a notification (identifying that the threshold condition has been met) is automatically transmitted by container A 515 or one of its associated servers to a user device 640 (e.g., a desktop computer, a laptop, a tablet device, a smartphone, a wearable device, a gaming console, a smart television, a media center device), which may then display an alert/notification 630 that includes that notification of step 620.

The example alert/notification 630 illustrated in FIG. 6A reads “EU sales have surpassed US sales” based on a determination that a first value of EU sales at a certain point along a time axis is greater than (“>”) a second value of US sales at that point along the time axis, illustrated also based on an intersection of a first graph line of a in the composite analytic visualization 555 with a second line in the composite analytic visualization 555. Thus, the user device 640 has received the alert/notification 630 to notify him/her that European Union (EU) sales have surpassed (are greater than) United States (US) sales at a particular past or present time, perhaps indicating that company resources should be diverted, or perhaps indicating that a United States salesman or sales team is underperforming. Such an alert/notification 630 could go to a manager overseeing such sales teams or to such salesperson himself/herself, and may for example be used to terminate his/her employment at the company.

FIG. 6B is a flow diagram illustrating user device notifications based on predictions based on container chart data.

In cases such as those illustrated in FIG. 6B, alerts/notifications 630 can also be triggered by various predictions or forecasts. In particular, the data from the composite analytic visualization 555 of FIG. 6B is analyzed at step 650, and trends/correlations/regressions 655 are generated based on the data. These trends/correlations/regressions 655 may be generated using statistical correlations, statistical regressions, trend analysis, statistical modeling, simulations, mathematical averages, standard deviations, artificial intelligence algorithms, machine learning algorithms, matrix operations, or some combination thereof.

At step 660, a future point along an axis is identified where some equality or inequality condition is predicted/forecast to be met in one of the particular ways discussed above (>, ≧, =, <, ≦). This equality or inequality condition may be an absolute threshold condition or a relative threshold condition as discussed with respect to FIG. 6B. In the example of FIG. 6B, step 660 identifies an example of an absolute threshold condition, namely that a predicted point along “chart_A” at a future “trendpoint_Z” along the time axis being greater than or equal to (“≧”) an absolute amount, namely 12000 units. Step 660 also identifies an example of a relative threshold condition, namely that a first point along “chart_A” at a “trendpoint_Z ” along the time axis being greater than (“>”) a second point along “chart_B” at the “trendpoint_Z” along the time axis.

At step 670, the alert/notification 630 of FIG. 6B is then triggered to be sent to the user device 640 in much the same way as the alert/notification 630 of FIG. 6A is, but based on the predictions extrapolated in step 650 and the conditions detected in step 660.

The alert/notification 630 sent following step 620 of FIG. 6A or following step 660 of FIG. 6B can be sent to one or more user(s) and/or to one or more user device(s) 640. That is, a single user can send an individual-type alert request to a container or update server, detailing conditions that should trigger sending of an alert/notification 630. That user can then receive the alert/notification 630 at one or more user device(s) 640 associated with that user following the sending the individual-type alert request. Alternately, the user can send a group-type alert request to a container or update server. The group-type alert request can detail conditions that should trigger sending of an alert/notification 630 as well as users that should receive the alert/notification 630 if the user is creating a setting for the alert/notification 630. The group-type alert request can alternately simply identifying an existing group notification that the user.

An alert/notification 630 may be triggered by detection of a variety of equality or inequality conditions detected in step 620 of FIG. 6A or step 660 of FIG. 6B. For example, an alert/notification 630 may be triggered by detection of a first value A being greater than a second value B (“A>B”), a first value A being equal to a second value B (“A=B”), a first value A being less than a second value B (“A<B”), a first value A being greater than or equal to a second value B (“A≧B”), or a first value A being less than or equal to a second value B (“A≦B”). Various mathematical operations may be involved in this operation—for example, an alert/notification 630 may be triggered by a first mathematical combination of values from along various graph lines comparing to a second mathematical combination of values of a second mathematical combination of values from along various graph lines in one of the particular ways discussed above (>, ≧, =, <, ≦). Such mathematical combinations used in steps 620 and 660 may include sums, differences, ratios, products, exponential functions, trigonometric functions, logarithmic functions, polynomial functions, algebraic functions, statistical functions, matrix functions, or some combination thereof. In addition to the data source(s) 170, at least some of the data for these comparisons can also be pulled from various other sources on the public Internet or private databases. In addition to the data source(s) 170, at least some of the data for the comparisons of steps 620 and 660 can also be pulled from various other sources on the public Internet or private databases.

FIG. 7A illustrates a first form of exemplary visualization update as transferred from an update server to a container embedded within a portal.

The first form of the visualization update 220 may include the processed data sets and metadata 710 stored at the update server(s) 140 and/or at other container(s) 190 (and/or their associated servers). In particular, the processed data sets depicted in FIG. 7A are the processed data sets of FIG. 2, namely, processed data set 215A, processed data set 215B, and processed data set 215C. Using this form of visualization update 220, the container 130 receives the visualization update 220 and uses the processed data sets and metadata 710 to generate an updated version of the analytic visualization 110. This first form of the visualization update 220 may be useful to put less stress on the update server(s) 140, since the update server(s) 145 do not need to generate the updated version of the analytic visualization 110.

The other container(s) 190 (and/or their associated servers) may transmit a visualization update 220 either through to the update server(s) 140 associated with the container 130, or may transmit the visualization update 220 directly to the container 130.

FIG. 7B illustrates a second form of exemplary visualization update as transferred from an update server to a container embedded within a portal.

The second form of the visualization update 220 may include data corresponding to an updated version of the analytic visualization 110. Update server(s) 140 and/or other container(s) 190 (and/or their associated servers)that use this form of visualization update 220 may use the processed data sets and metadata 710 to generate, at the update server(s) 140 and/or at the other container(s) 190 (and/or their associated servers), data corresponding to an updated version of the analytic visualization 110. The processed data sets depicted in FIG. 7B are the processed data sets of FIG. 2, namely, processed data set 215A, processed data set 215B, and processed data set 215C. Once the container 130 receives the visualization update 220, it simply displays the updated version of the analytic visualization 110 based on the data corresponding to the updated version of the analytic visualization 110 that was already generated by the update server(s) 140. This second form of the visualization update 220 may be useful when generating an updated version of the analytic visualization 110 is particularly resource-intensive (which may be useful when the device executing the container 130, such as the viewer device, is not powerful).

As in FIG. 7A, the other container(s) 190 (and/or their associated servers) may transmit a visualization update 220 either through to the update server(s) 140 associated with the container 130, or may transmit the visualization update 220 directly to the container 130.

FIG. 8 is a flow diagram illustrating data processing operations performed by a data server to generate a processed data set. The flow diagram of FIG. 8 also shows exemplary data stored in a data server memory 800 of the exemplary data server X 250 of FIG. 2, and exemplary data stored in an update server memory 860 of exemplary update server(s) 140. The exemplary data processing operations of FIG. 8 describe only data source A 260 and related operations; it should be understood that similar operations will be performed in parallel (or at least partly in series) pertaining to data source B 265 of data server X 250 and pertaining to data source C 280 of data server Y 270. The exemplary data processing operations of FIG. 8 may be at least partially performed by the update plugin 155 stored in the data server memory 800 of the data server(s) 145.

The exemplary data processing operations may begin with accessing a data source A 260 within the data server memory 800 of the data server(s) 145 (step 810) after the data server X 250 receives data processing instruction 210A and identifier 205. Optionally, the exemplary data processing operations may also include obtaining additional data 890 stored at the external server(s) 150 (step 815). Optionally, the exemplary data processing operations may also include obtaining additional data 895 stored at the other containers 190 or their associated server(s) (e.g., a container server, an update server 140, a data server 145, an external server 150, or some combination thereof associated with the one or more other containers 190) (step 815).

The exemplary data processing operations may then begin filtering data from the data source A 260 as well as from the additional data 890 and/or additional data 895 if applicable (see step 820, step 830, and step 840). These filtering steps, described below, may be performed in any order. Once the filtering steps are performed, the processed data set 215A is generated (step 850) such that any data that has not been filtered out is included in the processed data set 215A.

The filtering steps (see step 820, step 830, and step 840) may be performed a number of ways. For example, the filtering steps may involve generating a copy of the data source A 260, as well as from the additional data 890 and/or additional data 895 if applicable, and removing data at each filtering step until the data for the processed data set is all that remains. Alternately, the filtering steps may involve generating a new copy for every filtering step. Alternately, the filtering steps may be performed by noting memory and/or data structure locations (e.g., pointers) to data that has been, or that has not yet been, filtered out, and then generating the processed data set based on the noted memory and/or data structure locations. The filtering steps can also be generated using some combination of these methods, or another method entirely. FIG. 8 depicts filtered data source A 870 as broadly representing each of these possible methods of applying data filters to data source A 260.

The filtering steps have three main stages (see step 820, step 830, and step 840), described below. An exemplary illustration of the filtering process is depicted in FIG. 8 as the filtered data source A 870.

In particular, the filtering steps may filter the data based on permission settings associated with the identifier 205 (step 820), and in some cases additional permission settings stored in the additional data 895. For example, if the viewer of the analytic visualization 110 is the high-ranking company executive of a company, the permission settings associated with the high-ranking company executive's identifier 205 could filter out little, if any, of the data from the data source A 260 (and additional data 890 and/or additional data 895 if applicable), since the high-ranking company executive should be able to see any relevant data in order to best lead the company. In contrast, if the viewer of the analytic visualization 110 is a member of the public (and potentially an employee of a competitor), the permission settings associated with the public viewer's identifier 205 could filter out much, if not all, of the data from the data source A 260 (and additional data 890 and/or additional data 895 if applicable). If the viewer of the analytic visualization 110 is a regional manager of the company, the permission settings associated with the regional manager's identifier 205 filter out any data not relevant to the regional manager's own managed region from the data source A 260 (and additional data 890 and/or additional data 895 if applicable). In some cases, permission settings may bar certain individuals from seeing any data of an entire data category (e.g., employee evaluation reports) or any data from an entire data source (e.g., a data source storing trade secrets). Additionally, if the container 130 has been given access to data from another container, for example via a process similar to the one illustrated in FIG. 5, permissions may be transferred via the additional data 895 from those other containers and/or their associated server(s). For example, a second container (not pictured) of the other containers 190 may include permissions to use additional portions of data source A 280. In particular, then, the additional data 895 may in some cases include identifiers or permissions to more data that is stored on data server X 250 or another data server. Any data filtered out during filtering step 820 is then not included in the processed data set 215A when the processed data set 215A is generated in step 850.

The filtering steps may also filter the data based on the data request 200 (step 830). For example, if the data source A 260 (and the additional data 890 and/or additional data 895 if applicable) contain worldwide sales data, but the data request 200 indicates that the viewer only wishes United States sales data in the analytic visualization 110, then any worldwide sales data not pertaining to the United States could be filtered out so as not to be included in the processed data set 215A when the processed data set 215A is generated in step 850.

The filtering steps may also filter the data based on metadata 510 (step 840). The metadata 510 may include various information describing the data in the analytic visualization 110, such as graph axes (e.g., time, money, geographic location, votes, cost, sales, or similar categories of data), the type/format of the analytic visualization 110 (e.g., line graph, bar chart, pie chart, or any of the other possible types of analytic visualization 110), the composite analytic visualization type (e.g., side-by-side comparison or mathematical operations as described further in FIG. 7), information about where the data from the analytic visualization 110 is stored, or other data. Metadata 510 may be used to filter data from the data source A 260 (and the additional data 890 and/or additional data 895 if applicable) in certain circumstances. For example, if the data source A 260 includes sensor measurement data taken every 5 seconds, but the metadata 510 indicates that the analytic visualization 110 is a line graph charting sensor measurement data at 10 second intervals, then half of the data could be filtered out so as not to be included in the processed data set 215A when the processed data set 215A is generated in step 850.

Once the data server(s) 145 generate the processed data set 215A (step 850), the data server(s) 145 may transmit the processed data set 215A to the update server(s) 140 to be stored in an update server memory 860 of the update server(s) 140. The update server memory 860 could also store other datasets, such as the data request 200 from the container 130, the identifier 205 from the container 130, and the metadata 510. The update server(s) 145 may then use the processed data set 215A to generate the visualization update 220 as described in FIG. 2, FIG. 4, FIG. 7A, and/or FIG. 7B.

FIG. 9 illustrates various exemplary types of composite analytic visualizations. These composite visualizations can be used with multiple subsets of the same data source (of the data sources 170), multiple data sources (of the data sources 170), data from the container 130 mixed with data from one or more other container(s) 190 and/or their associated server(s), or some combination thereof.

In particular, FIG. 9 illustrates side-by-side comparisons 900 and mathematical combinations 930. Other types of composite analytic visualizations may also be possible, such as composite analytic visualizations that include a combination of a side-by-side comparison 900 and mathematical combination 930, such as a side-by-side comparison of different mathematical combinations.

The first type of composite analytic visualization illustrated in FIG. 9 is the side-by-side comparison 900. A side-by-side comparison 900 gathers the two or more data sets and displays them so that they can be compared. For example, composite analytic visualization 910 shows a composite line graph with three separate lines representing three separate data sets (e.g., three subsets of a data source, three data sources, data from three containers and their associated servers, or some combination thereof). Composite analytic visualization 920 shows a composite bar chart with two sets of bars representing two separate data sets (e.g., two subsets of a data source, two data sources, data from two containers and their associated servers, or some combination thereof).

The second type of composite analytic visualization illustrated in FIG. 9 is the mathematical combination 930. A mathematical combination 930 gathers data from two or more sets and displays them after performing a mathematical operation that turns the two or more data sources into a single data set that represents the result of the mathematical operation. For example, composite analytic visualization 940 shows a composite line graph with a single line representing the average value of data from three separate data sets (e.g., three subsets of a data source, three data sources, data from three containers and their associated servers, or some combination thereof). Composite analytic visualization 950 shows a composite bar chart with a single set of bars representing a difference between data from two separate data sets (e.g., two subsets of a data source, two data sources, data from two containers and their associated servers, or some combination thereof).

In some situations, different data sets may require conversions to be performed before they are combined into a composite analytic visualization. For example, if a first data set includes distance data in miles while a second data set includes distance data in kilometers, the distance data from the second data set may be converted to miles before the composite analytic visualization is generated. This conversion may be performed by the update server(s) 145 or by the container 130.

Similarly, different data sets may require data mappings to be performed before they are combined into a composite analytic visualization so that data can properly be compared (e.g., if the first data set includes time increments of 5 seconds while the second data set includes time increments of 10 seconds). A data mapping may allow the data from the first data set to line up with the data from the second data set. In some cases, data mappings may require extrapolation of data (e.g., if the first data set includes time increments of 2 seconds while the second data set includes time increments of 3 seconds, it may be difficult to get these data sets to line up without performing extrapolations of data between the given time increments). These data mappings may be performed automatically or with human interventional input (e.g., selecting the final interval to be used via interaction interface 135) or some combination thereof, and may be performed by the update server(s) 145 or by the container 130.

The third type of composite analytic visualization illustrated in FIG. 9 is the cascading chart 960. In this type, multiple data sets form cascading charts that provide additional information about a subset of information in a main chart either automatically or upon interaction (e.g., using interaction interface 135) with the main chart, the additional information formatted as an additional chart that may or may not be the same format. Example 970 illustrates a pie chart as the main chart, with a second pie chart cascading out of one “slice” of the main chart and a bar graph cascading out of a second “slice.” Example 980 illustrates a bar graph as the main chart, with a pie chart cascading out of one bar of the main chart and a line graph cascading out of a second bar of the main chart.

FIG. 10 illustrates an exemplary computing system 1000 that may be used to implement an embodiment of the present invention. The computing system 1000 of FIG. 10 includes one or more processors 1010 and memory 1010. Main memory 1010 stores, in part, instructions and data for execution by processor 1010. Main memory 1010 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and main memory 1010 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing embodiments of the present invention for purposes of loading that software into main memory 1010.

Portable storage device 1040 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device 1040.

Input devices 1060 provide a portion of a user interface. Input devices 1060 may include an alpha-numeric keypad, such as a keyboard, for inputting alpha-numeric and other information, or a pointing device, such as a mouse, a trackball, stylus, or cursor direction keys. Additionally, the system 1000 as shown in FIG. 10 includes output devices 1050. Examples of suitable output devices include speakers, printers, network interfaces, and monitors.

Display system 1070 may include a liquid crystal display (LCD), a plasma display, an organic light-emitting diode (OLED) display, an electronic ink display, a projector-based display, a holographic display, or another suitable display device. Display system 1070 receives textual and graphical information, and processes the information for output to the display device. The display system 1070 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 1080 may include any type of computer support device to add additional functionality to the computer system. For example, peripheral device(s) 1080 may include a modem or a router.

The components contained in the computer system 1000 of FIG. 10 are those typically found in computer systems that may be suitable for use with embodiments of the present invention and are intended to represent a broad category of such computer components that are well known in the art. Thus, the computer system 1000 of FIG. 10 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 1000 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various flow diagrams have been described above, it should be understood that these show a particular order of operations performed by certain embodiments of the invention, and that such order is exemplary. Alternative embodiments can perform the operations in a different order, combine certain operations, or overlap certain operations depicted in the flow diagrams.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method of providing composite analytic visualization data, comprising:
identifying at least a first data type that characterizes at least a subset of a first dataset that is visualized in a first analytic visualization output to a viewer device by a first container, the first dataset including data stored at one or more data servers that was selected by the one or more data servers according to data processing instructions sent to the one or more data servers by one or more update servers communicatively coupled to the first container, the data processing instructions based at least partially on permissions associated with the viewer device;
transmitting a container query to a server associated with a second container displaying a second analytic visualization that visualizes a second dataset, the container query identifying at least the first data type;
receiving a container dataset from the server associated with the second container, the container dataset being at least a subset of the second dataset that matches the first data type;
generating a composite dataset based at least partially on at least a subset of the first dataset and at least a subset of the container dataset;
generating a composite analytic visualization that visualizes the composite dataset;
outputting the composite analytic visualization at the first container; and
displaying the first container at the viewer device.

2. The method of claim 1, further comprising converting data from the container dataset from a second measurement unit to a first measurement unit that is used by the first container.

3. The method of claim 1, wherein the permissions associated with the viewer device are based on an identifier associated with the viewer device, the identifier transmitted to the one or more data servers by the update server, the update server having received the identifier from the first container.

4. The method of claim 3, wherein the permissions are identified within the identifier.

5. The method of claim 3, wherein the permissions are provided by a security server in exchange for receipt of the identifier.

6. The method of claim 1, wherein the composite analytic visualization includes a plurality of analytic visualizations displayed side-by-side, the plurality of analytic visualizations including at least a first derivative analytic visualization based on the first dataset and a second derivative analytic visualization based on the second dataset.

7. The method of claim 1, wherein generating the composite dataset includes performing at least one mathematical operation that includes at least one first data point from the first dataset and at least one container datapoint from the container dataset.

8. The method of claim 7, wherein the at least one mathematical operation includes at least one of a difference, a sum, a ratio, a multiplication product, an exponential operation, an average, or some combination thereof.

9. The method of claim 1, wherein the composite analytic visualization is a cascading analytic visualization that provides more detailed information about part of the composite analytic visualization using a subordinate analytic visualization.

10. The method of claim 1, wherein the composite analytic visualization is one of a line graph, a bar chart, a pie chart, an area graph, a scatter plot, a volume graph, a surface graph, a doughnut chart, a bubble chart, a box plot, a radar chart, a sparkline chart, a cone chart, a pyramid chart, a stock chart, a histogram, a Gantt chart, a waterfall chart, a binary chart, a pictograph, an organizational chart, a flow chart, a map, a gauge, a table, or some combination thereof.

11. The method of claim 1, wherein the container is embedded in a portal, and wherein the portal is a network entity accessible through one of the a private network intranet or the public Internet.

12. The method of claim 1, wherein the server associated with the second container is a second container server hosting the second container.

13. The method of claim 1, wherein the server associated with the second container is an update server of the one or more update servers.

14. The method of claim 1, wherein the server associated with the second container is a data server of the one or more data servers.

15. The method of claim 1, wherein the one or more data servers include one or more external servers, the one or more external servers including at least one of a Google BigQuery server, a Google CloudSQL server, a Google BigTable server, an Amazon RedShift server, an Amazon DynamoDB server, a Microsoft Azure SQL server, an Amazon EC2-based server, an Google Compute-based server, a mapreduce-based server, a hadoop-based server, an Apache HBase-based server, a MongoDB-based server, or some combination thereof.

16. A system for providing composite analytic visualization data, comprising:
a first container outputting a first analytic visualization that visualizes a first dataset, the first container displayed to a viewer device;
a second container outputting a second analytic visualization that visualizes a second dataset;
a data server plugin stored at one or more data servers, wherein the one or more data servers also collectively store one or more data sources, wherein the first dataset includes at least a first selection of data from at least a first subset of the one or more data sources, the first selection of data based at least partially on permissions associated with the viewer device, and wherein the second dataset includes at least a second selection of data from at least a second subset of the one or more data sources; and
one or more update servers communicatively coupled to the one or more data servers, wherein the first container is communicatively coupled to at least a first subset of the one or more update servers and the second container is communicatively coupled to at least a second subset of the one or more update servers, the one or more update servers including an update server memory and an update server processor, wherein execution of instructions stored in the update server memory by the update server processor:
identifies at least a first data type that characterizes at least a subset of the first dataset,
transmits a container query to a server associated with the second container, the container query identifying at least the first data type,
receives a container dataset from the server associated with the second container, the container dataset being at least a subset of the second dataset that matches the first data type,
generating a composite dataset based at least partially on at least a subset of the first dataset and at least a subset of the container dataset,
generating a visualization update based on the composite dataset;
transmitting the visualization update to the first container, thereby allowing the first container to output a composite analytic visualization generated based on the composite dataset.

17. The system of claim 16, wherein the server associated with the second container is a second container server hosting the second container.

18. The system of claim 16, wherein the server associated with the second container is an update server of the one or more update servers.

19. The system of claim 16, wherein the server associated with the second container is a data server of the one or more data servers.

20. A non-transitory computer-readable storage medium, having embodied thereon a program executable by a processor to perform a method for providing composite analytic visualization data, the method comprising:
identifying at least a first data type that characterizes at least a subset of a first dataset that is visualized in a first analytic visualization output to a viewer device by a first container, the first dataset including data stored at one or more data servers that was selected by the one or more data servers according to data processing instructions sent to the one or more data servers by one or more update servers communicatively coupled to the first container, the data processing instructions based at least partially on permissions associated with the viewer device;
transmitting a container query to a server associated with a second container displaying a second analytic visualization that visualizes a second dataset, the container query identifying at least the first data type;
receiving a container dataset from the server associated with the second container, the container dataset being at least a subset of the second dataset that matches the first data type;
generating a composite dataset based at least partially on at least a subset of the first dataset and at least a subset of the container dataset;
generating a composite analytic visualization that visualizes the composite dataset;
outputting the composite analytic visualization at the first container; and
displaying the first container at the viewer device.
